(19) United States
(12) Patent Application Publication
(10) Pub. No.: US 2026/0088900 A1
(43) Pub. Date: Mar. 26, 2026

(54) SYSTEMS AND METHODS FOR FIBER LINE MONITORING

(71) Applicant: Comcast Cable Communications, LLC, Philadelphia, PA (US)

(72) Inventors: Venk Mutalik, Philadelphia, PA (US); Amarildo Vieira, Philadelphia, PA (US); Daniel Rice, Philadelphia, PA (US); Charles Conte, Philadelphia, PA (US); Athreya Karkada Nakshathri, Philadelphia, PA (US); Scott Wood, Philadelphia, PA (US); Robert Gaydos, Philadelphia, PA (US); Sarah Sam, Philadelphia, PA (US)

(21) Appl. No.: 18/891,956

(22) Filed: Sep. 20, 2024

(51) Int. Cl. H04B 10/079; H04B 10/40

(52) U.S. Cl. CPC H04B 10/0795; H04B 10/40

(57) ABSTRACT

An example method described herein may include transmitting, via an optical fiber and an optical circulator coupled to an optical transceiver, an optical signal. The example method may include receiving transmission data indicative of reception or loss of the optical signal via the optical fiber. The example method may include determining, based on at least the transmission data, fiber data indictive of at least a condition of the optical fiber.

### BACKGROUND

The cost associated with constructing fiber optic lines is expensive. For that reason, when a need arises to lay a single fiber optic line, many lines are also placed with the single fiber optic line for future use. The other lines that are not currently in use are called dark fiber. Often, dark fiber is not well tracked on network documentation. Additionally, the connectivity and performance status of dark fiber is not known.

Improvements are needed.

### SUMMARY

It is to be understood that both the following general description and the following detailed description are exemplary and explanatory only and are not restrictive. Methods and systems for managing fiber networks are described.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Methods described herein may include transmitting, via an optical fiber and an optical circulator coupled to an optical transceiver, an optical signal. Methods may also include receiving transmission data indicative of reception or loss of the optical signal via the optical fiber. Methods may furthermore include determining, based on at least the transmission data, fiber data indictive of at least a condition of the optical fiber. Other embodiments of this aspect include corresponding computer systems, apparatus, and computer programs recorded on one or more computer storage devices, each configured to perform the actions of the methods.

Methods may include transmitting, via a transmit port of an optical transceiver, via an optical circulator optically coupled to the optical transceiver, and via an optical fiber optically coupled to the optical circulator, an optical signal, where the optical circulator is non-reciprocal and is configured to unidirectionally pass the optical signal from the transmit port to the optical fiber. Methods may include receiving transmission data indicative of reception or loss of the optical signal via the optical fiber. Methods may include determining, based on at least the transmission data, fiber data indictive of at least a condition of the optical fiber. Other embodiments of this aspect include corresponding computer systems, apparatus, and computer programs recorded on one or more computer storage devices, each configured to perform the actions of the methods.

Methods may include causing, at a first hub, an optical signal to be transmitted via a transmit port of a first optical transceiver, via an optical circulator optically coupled to the first optical transceiver, and via an optical fiber optically coupled to the optical circulator, where the optical circulator is non-reciprocal and is configured to unidirectionally pass the optical signal from the transmit port to the optical fiber. Methods may include receiving transmission data indicative of reception or loss of the optical signal via the optical fiber. Methods may include determining, based on at least the transmission data, fiber data indictive of at least a condition of the optical fiber. Other embodiments of this aspect include corresponding computer systems, apparatus, and computer programs recorded on one or more computer storage devices, each configured to perform the actions of the methods.

Methods may include receiving transmission data indicative of reception or loss of an optical signal via an optical fiber, where the optical signal is received via an optical circulator coupled to a receive port of an optical transceiver, where the optical circulator is non-reciprocal and is configured to unidirectionally pass the optical signal from the optical fiber to the receive port. Methods may include determining, based on at least the transmission data, fiber data indictive of at least a condition of the optical fiber. Methods may include updating documentation associated with the optical fiber based on at least the fiber data. Other embodiments of this aspect include corresponding computer systems, apparatus, and computer programs recorded on one or more computer storage devices, each configured to perform the actions of the methods.

This summary is not intended to identify critical or essential features of the disclosure, but merely to summarize certain features and variations thereof. Other details and features will be described in the sections that follow.

### BRIEF DESCRIPTION OF THE DRAWINGS

Some features are shown by way of example, and not by limitation, in the accompanying drawings. In the drawings, like numerals reference similar elements.

FIG. 1 shows an example environment in which the systems and methods described herein may operate.

FIG. 2 shows an example fiber optic network in which the systems and methods described herein may operate.

FIG. 3 shows an example fiber optic network in which the systems and methods described herein may operate.

FIG. 4 shows an example device configured to facilitate communication from a hub via a fiber line according to the systems and methods described herein.

FIG. 5 shows a schematic of a circulator of the present disclosure.

FIGS. 6A-6E show example schematic drawings of the example device shown in FIG. 4.

FIG. 7 shows an example handheld device configured to facilitate communication via a fiber line according to the systems and methods described herein.

FIGS. 8A-8C show an example flow diagram of an example method described herein.

FIG. 9 shows an example truth table associating attributes with a fiber status according to the systems and methods described herein.

FIG. 10 shows an example mapping of a connection between two hubs.

FIG. 11 shows example documentation automatically created by the systems and methods described herein.

FIG. 12 shows a flow diagram of an example method described herein.

FIG. 13 shows a flow diagram of an example method described herein.

FIG. 14 shows a flow diagram of an example method described herein.

The accompanying drawings show examples of the disclosure. It is to be understood that the examples shown in the drawings and/or discussed herein are non-exclusive and that there are other examples of how the disclosure may be practiced.

### DETAILED DESCRIPTION

The present disclosure relates to systems and methods for detecting dark fiber. For example, a dark fiber line may be cut and become unusable in the effort to repair the active fibers, but because the dark fiber line is not monitored, it is still considered usable. As a further example, since conventional dark fiber is not monitored, new fiber line may be installed when not necessary, as the dark fiber may be functional, just unused or unknown. When needed for use understanding characteristics of fiber often requires manual measurement and diagnostics to find its connectivity, utility and performance and where it is spliced and its route, consuming human resources, time, labor and equipment expense. As such, the present disclosure describes the systems and methods of detecting, monitoring, and/or mapping fiber including dark fiber.

The systems and/or methods described herein may allow an administrator of an optical network to determine a source of a light (data, information, signals, etc.) by causing changes (adjustments, toggles, modulations, etc.) in status (state, etc.) in light sources (lasers, etc.) associated with transmit ports and observing changes in receive ports. A determination may be made of if light received at a receive port was transmitted from a local transmit port, a known remote transmit port, an unknown transmit port, or a reflection from light transmitted down an optical fiber from a neighboring port on a common non-reciprocal (circulator, etc.) device may be determined. A port and/or path from the port may be categorized based on observations associated with the changes in the light sources associated with the transmit ports. Determinations about the path, such as latency, connectivity, etc., may be made based on the observations. Determinations may be made based on information contained in the light.

Disclosed herein are systems and methods for an innovative combination of non-reciprocal optical materials (circulators, etc.) and packaging thereof (such as in a small form-factor pluggable (SFP)), augmentation of switch and router protocols (such as using virtual routing and forwarding (VRF) to overcome a logical loopback for testing), systematic analyzation and documentation of optical fiber properties (including characterization of dark fibers, including vital statistics (such as power budgets, fiber lengths, fiber cut locations, etc.) in real time across entire markets), a handheld device described herein to aid discovery of stranded fiber in the field, etc.

Documentation, as used herein may comprise any form of information storage or record including digital or analog. Documentation may comprise analytics of the captured data and information, annotations, classifications, ordering, organization, summaries, visualizations, predictions, or other processing of the raw the data.

A network provider may manage a very large fiber network. Fiber documentation may be poor, resulting in missed opportunities for interconnecting customers. Missed opportunities may be caused by delays in locating available fibers and/or costly construction projects overlaying fiber where fiber assets may have existed. Additionally, the network provider may use less efficient routes of connection than was available if full knowledge of the fiber optic network were available, including knowledge of dark fibers, resulting in a network comprising more latency and or more expensive optical components than was necessary.

Even if excellent documentation of dark fibers were kept, the documentation may become stale quickly. Fibers are prone to cuts constantly, and, often, dark fibers that are cut are not restored to full service in an effective way. As a network evolves, varying fiber counts may be deployed at different times, sometimes with undocumented changes, resulting in many strands unable to connect.

Current documentation techniques are static and are recorded when the fiber optics are placed. When a network provider acquires existing networks, documentation associated with acquired networks may be different and/or incomplete. As actual conditions change (such as unused fibers being cut, unused equipment being damaged, etc.) any intelligible, complete documentation from existing networks will quickly become stale. Also, documentation needs to be updated as maintenance and/or new construction of fiber assets occurs. Updating documentation, when it happens, is prone to human operator compliance and/or fatigue.

There is thus a need for automatic discovering, monitoring, surveying, and/or documenting fiber optic lines (cables, links, connections, etc.) and/or fiber assets, particularly dark fiber assets. Described herein are systems and methods for the use of computing modeling, artificial intelligence (AI), and/or machine learning (ML) to automatically discover, map, and monitor dark fibers in a large fiber network. The discovery, mapping, and monitoring may be continuous and pervasive. The systems and methods described herein may enable a network provider to acquire new customers, capture more applications, be more responsive, better serve existing customers better, and improve reliability and capacity of a fiber network.

The systems and methods described herein provide a cost-effective platform to enable automatic discovery of fiber assets. The systems and methods described herein continuously and pervasively monitor the fiber assets and facilitate sophisticated data techniques to help allow for more responsiveness and more reliability, resulting in a better customer experience.

Fiber optic lines exiting a hub (headend, optical transport network (OTN) or central office, etc.) of a network provider may be collected in termination ports within termination panels within the hub. A hub may comprise thousands of termination ports, each may correspond to a fiber line leaving the hub. Unfortunately, once a fiber line leaves the hub, documentation associated with the fiber line is manual and prone to substantial error and/or misrepresentation.

The systems and methods described herein may apply light to a first port, wherein the light comprises a unique signature. If the light is detected at a second port, then a connection between the first port and the second port may be determined. A distance associated with the connection may also be determined based on a difference in time between when the light was applied to the first port and when the light was detected at the second port. If the light is not detected at any other port, then a fiber line associated with the first port may be determined to be broken and a path associated with the fiber line may be determined to be unusable. The systems and methods described herein may use data models to predict the fiber routes taken and to determine how to resurrect fiber routes that are now broken. The systems and methods described herein allow a network provider to be proactive and fix fiber routes more routinely, rather than waiting for an emergency to occur before taking action. Finally, existing connected dark fiber lines may be automatically documented and continuously monitored and made visible to the network provider so that customer requests may be promptly serviced.

The systems and methods described herein may use new network components. Typically, light from a common source, such as a small form-factor pluggable (SFP), requires two separate fiber lines to traverse and complete a loop—one to transmit a signal to a receive port and one to receive a signal from a transmit port. However, using two fiber lines is a not an option in addressing the problems described above, because each fiber line needs to be detected individually and any two fibers may route to different locations. Multiplexing techniques do not address the problems described above—combining incoming and exiting light does not help because the same wavelengths are used in both directions, making it impossible to demultiplex the light. Common optical time-domain reflectometer (OTDR) techniques do not address the problems described above, because the OTDR techniques just provide fiber distance, not connectivity information.

The systems and methods described herein use a circulator-based device that enables simultaneous same wavelength transmission and reception on a single fiber line so that the fiber line may be individually detected. In the process of detection, the systems and methods described herein also may measure the outgoing and incoming light levels. The systems and methods described herein may then use a mature link layer discovery protocol (LLDP) on inexpensive switches to track neighbor ports and detect and document port connectivity and attenuation information automatically. The systems and methods described herein may use message and response pairs (ping messages, etc.) on an established connection to estimate a latency of the connection. The systems and methods described herein may pervasively monitor dark fiber lines in a cost effective, low wattage, and unintrusive manner. The systems and methods described herein may activate an alarm in response to fiber asset cuts and/or impairments. Since fiber assets may be completely documented by this system, connecting new links may be easy. Since fiber assets may be completely documented by this system, costly fiber asset efforts that are single point in time status checks and prone to substantial delays and costs may be prevented unless actually needed in light of an actual state of a fiber network.

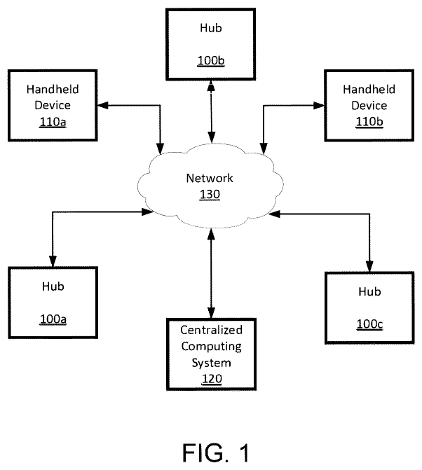

FIG. 1 shows an example environment in which the systems and methods described herein may operate. The example environment comprises multiple hubs 100a-c, multiple handheld devices 110a-b, and a centralized computing system 120 connected via a network 130.

Each of the hubs 100a-c may comprise one or more ports. The one or more ports may be configured to receive a fiber optic line. One or more of the hubs 100a-c may be associated with a network provider. One or more of the hubs 100a-c may comprise a headend, central office, optical transport network (OTN) facility, etc. One or more of the hubs 100a-c may be in communication with the network 130 via a fiber optic connection. One or more of the hubs 100a-c may be in communication with the network 130 via a connection that is not a fiber optic connection. One or more of the hubs 100a-c may apply light to at least one associated port to determine network information. One or more of the hubs 100a-c may receive light from at least one associated port to determine network information. Network information may comprise connectivity information, latency information, security information, etc. The network information may be transmitted via the network 130 to the centralized computing system 120.

Each of the handheld devices 110a-110b may comprise a component to couple a handheld device 110a-110b to a fiber optic line. One or more of the handheld devices 110a-110b may be associated with a network provider. One or more of the handheld devices 110a-110b may be in communication with the network 130 via a fiber optic connection. One or more of the handheld devices 110a-110b may be in communication with the network 130 via a connection that is not a fiber optic connection. One or more of the handheld devices 110a-110b may apply light to a fiber line to determine network information. One or more of the handheld devices 110a-110b may receive light from a fiber line to determine network information. Network information may comprise connectivity information, latency information, security information, etc. The network information may be transmitted via the network 130 to the centralized computing system 120.

The centralized computing system 120 may comprise one or more servers. The centralized computing system 120 may comprise a cloud computing environment. The centralized computing system 120 may centralize information regarding a fiber optic network, while being physically decentralized. For example, the centralized computing system 120 may comprise a distributed ledger. The centralized computing system 120 may be associated with a network provider. The centralized computing system 120 may be in communication with the network 130 via a fiber optic connection. The centralized computing system 120 may be in communication with the network 130 via a connection that is not a fiber optic connection. The centralized computing system 120 may receive information about a fiber optic network from the hubs 100a-c and/or the handheld devices 110a-b. The centralized computing system 120 may dynamically create, store, and/or update determinations about the fiber optic network based on the information received from the hubs 100a-c and/or the handheld devices 110a-b. Determinations about the fiber optic network may comprise connectivity determinations, latency determinations, security determinations, new construction determinations, etc. The centralized computing system 120 may continuously monitor the fiber optic network.

The network 130 may comprise a private network. The network 130 may be owned by the network provider. The network 130 may comprise a public network, such as the Internet. The network 130 may comprise the fiber optic network monitored by the centralized computing system 120. The network 130 may be separate from the fiber optic network monitored by the centralized computing system 120. The network 130 may be connected through fiber leased or indefeasible right of use (IRU) agreements and owned by many network operators. The centralized computing system 120 may be monitoring multiple fiber operators such as at an Internet peering facility or public or private cloud facility supporting a single or many operators.

A signal may be applied to a transmit port at hub 100a at a first time. The signal may comprise light. The signal may comprise a wavelength. The signal may comprise a unique signature. The signal may travel along a fiber optic line. The signal may be received, via the fiber optic line, at a receive port at hub 100a at a second time. A determination may be made that the signal received at the receive port is the same as the signal applied to the transmit port based on the unique signature. Hub 100a may transmit information about the transmitted signal (e.g., the transmit port, the first time, the receive port, the second time, etc.) to the centralized computing system 120 via the network 130. The centralized computing system 120 may determine that the fiber line is broken based on the transmit port and the receive port both being at hub 100a. The centralized computing system 120 may determine a length along the fiber line where the break occurred based on a difference between the second time and the first time. Alternatively, hub 100a may determine that the fiber line is broken and a length along the fiber line where the break occurred and transmit the determinations to the centralized computing system 120 via the network 130.

A signal may be applied to a transmit port at hub 100a at a first time. The signal may comprise light. The signal may comprise a wavelength. The signal may comprise a unique signature. The signal may travel along a fiber optic line. There may be an expectation, based on documentation, that the signal will be received at a first receive port at hub 100b. The signal may be received, via the fiber optic line, at a second receive port at hub 100c at a second time. Hub 100a may transmit first information about the transmitted signal (the transmit port, the first time, the first receive port at hub 100b, etc.) to the centralized computing system 120 via the network 130. Hub 100c may transmit second information about the transmitted signal (the second receive port, the second time, etc.) to the centralized computing system 120 via the network 130. The centralized computing system 120 may determine that a latency determined by a difference between the second time and the first time is more than would be expected for a fiber line from hub 100a to hub 100c. The latency determined by the difference between the second time and the first time may be as expected to travel from hub 100a to hub 100b and then to hub 100c. Inspection of the first receive port at hub 100b may reveal that the first receive port at hub 100b is coupled to a transmit port, which is in communication with a fiber line in communication with the second receive port.

A signal may be applied to a transmit port at hub 100a at a first time. The signal may comprise light. The signal may comprise a wavelength. The signal may comprise a unique signature. The signal may travel along a fiber optic line. Handheld device 110a may be in communication with the fiber line. Handheld device 110a may receive the signal at a second time. Hub 100a may transmit first information about the transmitted signal (the transmit port, the first time, etc.) to the centralized computing system 120 via the network 130. A computing device associated with handheld device 110a may transmit second information about the transmitted signal (location information (such as global positioning system (GPS) coordinates, the second time, etc.) to the centralized computing system 120 via the network 130. The centralized computing system 120 may update information associated with the fiber line to indicate that the line terminates at a location indicated by the location information.

Hub 100b may receive a signal at a receive port. The signal may comprise signal information (signature, wavelength, encoding, header, source, etc.). Hub 100b may transmit the signal information to the centralized computing system 120 via the network 130. The centralized computing system 120 may determine that the signal originated from an unknown (foreign, alien, etc.) source. The centralized computing system 120 may determine that a port on the opposite side of the receive port is an alien port. Although the centralized computing system 120 is described as making each determination, the hub 100b may make any determination and transmit the determination to the centralized computing system 120 via the network 130 for further processing.

The centralized computing system 120 may cause a plurality of signals may be applied to a transmit port at hub 100a during a first time range. The centralized computing system 120 may receive information related to the transmission of the plurality of signals, including the transmit port and a time associated with transmission of each of the plurality of signals. The plurality of signals may comprise light. The plurality of signals may be received, via a fiber optic line, at a receive port at hub 100b during a second time range. The centralized computing system 120 may receive information related to the reception of the plurality of signals, including the receive port and a time associated with reception of each of the plurality of signals. The centralized computing system 120 may determine that the transmit port and the receive port are connected via the fiber optic line based on at least the receive port, a time associated with transmission of at least one of the plurality of signals, the transmit port, and a time associated with reception of at least one of the plurality of signals. The centralized computing system 120 may determine that a time interval between a first time associated with transmission of a first signal of the plurality of signals and a second time associated with transmission of a second signal of the plurality of signals is a same time interval between a third time associated with reception of a third signal of the plurality of signals and a fourth time associated with reception of a fourth signal of the plurality of signals. The centralized computing system 120 may determine that time intervals between times associated with the transmission of each of the plurality of signals match time intervals between times associated with the reception of each of the plurality of signals. The centralized computing system 120 may use a time associated with transmission of at least one of the plurality of signals and a time associated with reception of at least one of the plurality of signals to determine a latency associated with the fiber line between the transmit port and the receive port.

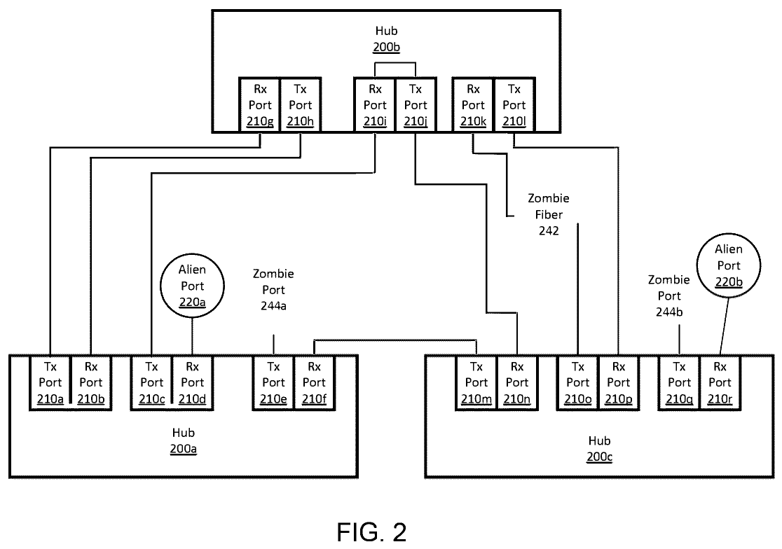

FIG. 2 shows an example fiber optic network in which the systems and methods described herein may operate. The example fiber optic network comprises hubs 200a-c, communication lines (cables, links, connections, etc.) connecting the hubs 200a-c, and issues, such as alien ports 220a-b, a zombie fiber 242, and zombie ports 244a-b. A zombie fiber may be a fiber that appears connected in documentation but is not actually connected. A zombie fiber may be a disconnected fiber, a cut fiber, a discontinuous fiber, an unsliced fiber, an unterminated fiber, etc. A zombie port may be a port that appears connected in documentation but is not actually connected. The hubs 200a-c comprise a plurality of ports 210a-r, including transmit ports 210a, 210c, 210e, 210h, 210j, 210l, 210m, 210o, 210q and receive ports 210b, 210d, 210f, 210g, 210i, 210k, 210n, 210p, 210r. The ports 210a-210r may comprise optical ports. An optical transceiver may comprise a transmit port and a receive port pair. The ports may be combined and embodied in a single unit or separate. For example, an optical transceiver may comprise transmit port 210a and receive port 210b. The systems and methods of the present disclosure may be applied to various ports (e.g., at scale) to detect, monitor, and or map dark fibers. As described herein, ports or fibers may be characterized in various manners. Independent of the characterizations used for illustration, herein, the systems and methods may be applied via a single fiber to determine various characteristics of said fiber. Because the systems and methods may be applied at a single fiber, such methods may be scaled across several independent fibers. Other applications may be used.

When a transmit port of one hub is connected to a receive port of another hub, a fiber connection is established between the hubs. For example, the link (line, cable, connection, path, etc.) between transmit port 210a and receive port 210g connects hub 200a with hub 200b (allowing hub 200a to transmit data to hub 200b), the link between transmit port 210h and receive port 210b connects hub 200a with hub 200b (allowing hub 200b to transmit data to hub 200a), the link between transmit port 210m and receive port 210f connects hub 200a and hub 200c (allowing hub 200c to transmit data to hub 200a), and the link between transmit port 210l and 210p connects hub 200b and hub 200c (allowing hub 200b to transmit data to hub 200c). When a link is not active (in use, or being tested by the method herein, etc.), the link is dark.

Connections between hubs may be established through multiple links. For example, the links between transmit port 210c and receive port 210i, receive port 210i and transmit port 210j, and transmit port 210j and receive port 210n establish a connection from hub 200a to hub 200c (allowing hub 200a to transmit data to hub 200c). Such a daisy chain connection from hub 200a to hub 200b and from hub 200b to hub 200c may have a higher latency than a direct connection from hub 200a to hub 200c. Daisy chain connections may also be dark.

Signals transmitted among the hubs 200a-c may comprise identifying features, such as a signature, encoding, header, wavelength, source, etc. The hubs 200a-c may acknowledge signals comprising expected (recognizable, etc.) identifying features. The signals may comprise optical signals.

An issue may arise when a receive port receives a signal that does not have the identifying features. For example, receive port 210d may receive a signal purporting to be from an unrecognized and/or unexpected source. The source of the signal received by receive port 210d may be designated as alien port 220a. As another example, receive port 210r may receive a signal that hub 200c cannot decode. The source of the signal received by receive port 210r may be designated as alien port 220b. An operator of the example fiber optic network may examine the fiber line connected to receive port 210d and/or 210r to determine what corrective action to take. Hub 200a may disable port 210d and/or disconnect port 210d from the fiber optic network. Hub 200c may disable port 210r and/or disconnect port 210r from the fiber optic network.

An issue may arise when a line is cut (broken, etc.). The resulting unusable line may be called a zombie line and/or zombie fiber. For example, the connection between transmit port 210o and receive port 210k has been cut and the result is zombie fiber 242.

An issue may arise when a line is connected to a first port, but never connected to a second port. The resulting line may be very small and hard to detect. When this happens, the resulting loose end of the fiber optic line may be called a zombie port. For example, transmit port 210e comprises zombie port 244a. As another example, transmit port 210q comprises zombie port 244b. Other example fiber conditions may exist, for example, fiber lines may be connected to a port but are unmapped or documented (e.g., dark fibers). By implementing the systems and methods of the present disclosure, such dark fibers may be discovered. Such discovery of dark fibers may, for example, limit the need to lay new fibers.

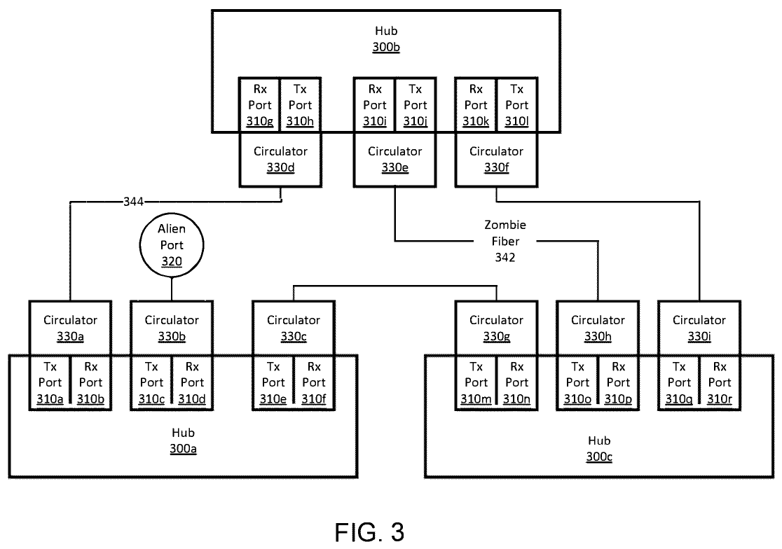

FIG. 3 shows an example fiber optic network in which the systems and methods described herein may operate. The example fiber optic network comprises hubs 300a-c, communication lines 344 (cables, links, connections, etc.) connecting the hubs 300a-c, and issues, such as an alien port 320, and a zombie fiber 342. The hubs 300a-c comprise a plurality of ports 310a-r, including transmit ports 310a, 310c, 310e, 310h, 310j, 310l, 310m, 310o, 310q and receive ports 310b, 310d, 310f, 310g, 310i, 310k, 310n, 310p, 310r. The ports 310a-310r may comprise optical ports. An optical transceiver may comprise a transmit port and a receive port pair. For example, an optical transceiver may comprise transmit port 210a and receive port 210b. The hubs 300a-c may comprise a plurality of circulators 330a-i. The circulators 330a-i may comprise optical circulators. A circulator may be coupled to a transceiver. For example, circulator 330a is coupled to transmit port 310a and receive port 310b. Although circulators 330a-i are shown, any non-reciprocal optical material may be used. For example, circulator 330a may be replaced by a pair of isolators. The circulators 330a-i may have and/or be disposed in a device comprising a plug form factor. The circulators 330a-i may have and/or be disposed in a device comprising a small form-factor pluggable (SFP) design. For example, circulator 330a (or a device in which circulator 330a is disposed) may be configured to plug into transmit port 310a and receive port 310b.

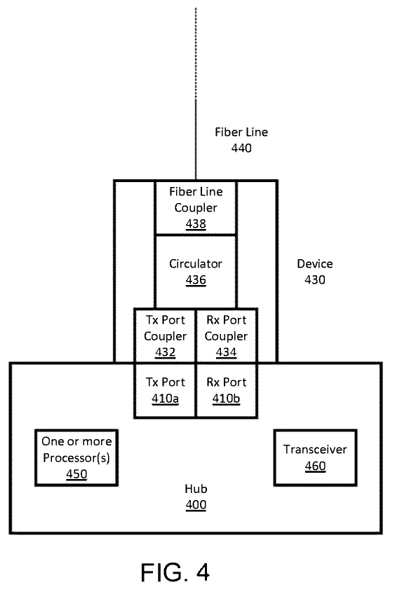

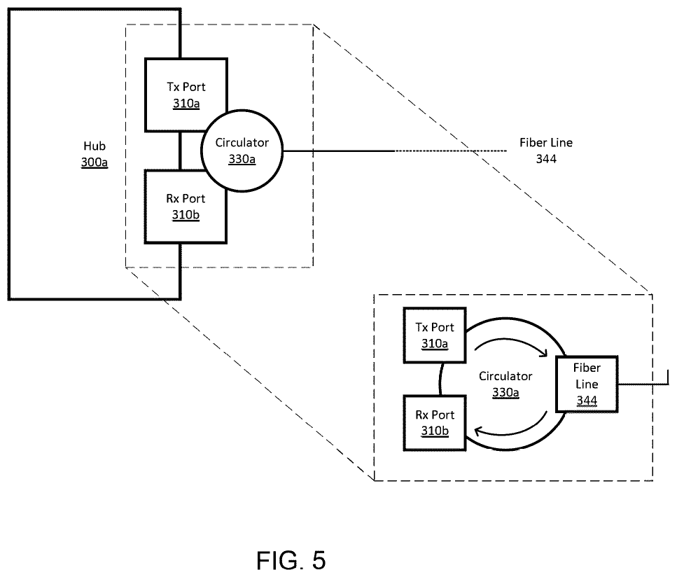

Referring to FIG. 5, a circulator of the present disclosure, such as circulators 330a-i (FIG. 3) or circulator 436 (FIG. 4) for example, may comprise a non-reciprocal device. As illustrated, the circulator may be coupled to a transmit port (e.g., 310a), a receive port (e.g., 310b), and a fiber line (e.g., 344). As such, the circulator may pass a transmit signal from the transmit port to the fiber line in a single direction (e.g., unidirectionally). The circulator (being non-reciprocal) may receive a signal from the fiber line, but will only pass the signal to the receive port (unidirectionally). In this way, the circulator may allow signals to pass over a single fiber line with directional signals (unidirectional) passing away from the transmit port or toward the receive port. As a further example, signals passing from the fiber line to the circulator will not be passed to the transmit port, but will instead be routed to the receive port. Such a device may be configured using optical material, reflection, opto-mechanical, electromechanical, or other configurations to manage direction optical signals, or other signal forms.

Although circulators 330a-i are shown separately from corresponding receive and transmit ports 310a-r, it is contemplated that a hub may integrate functionality associated with a circulator and a receive and transmit port pair into a single port.

Connections via circulators indicate two-way communication between hubs via the connections. For example, via the connection between circulator 330a and circulator 330d, hub 300a can send data to and receive data from hub 300b, and hub 300b can send data to and receive data from hub 300a via the connection between circulator 330a and circulator 330d. Similarly, two-way connection between hub 300a and hub 300c is facilitated via the connection between circulator 330c and circulator 330g. Similarly, two-way connection between hub 300b and hub 300c is facilitated via the connection between circulator 330f and circulator 330i.

Signals transmitted among the hubs 300a-c may comprise identifying features, such as a signature, encoding, header, wavelength, source, etc. The hubs 300a-c may acknowledge signals comprising expected (recognizable, etc.) identifying features. The signals may comprise optical signals.

An issue may arise when a receive port receives a signal that does not have the identifying features. For example, receive port 310d may receive a signal purporting to be from an unrecognized and/or unexpected source. The source of the signal received by receive port 310d may be designated as alien port 320. An operator of the example fiber optic network may examine the fiber line connected to receive port 310d to determine what corrective action to take. Hub 300a may disable port 310d, a transceiver comprising port 310d, circulator 330b coupled to port 310d, disconnect port 310d from the fiber optic network, disconnect a transceiver comprising port 310d from the fiber optic network, and/or disconnect circulator 330b coupled to port 310d from the fiber optic network. In addition to receiving a signal that does not have the identifying features, an issue associated with circulator 330b may be detected when transmit port 310c causes a signal to be transmitted, via circulator 330b on a fiber line and the signal is not detected at any hub 300a-c in the example fiber optic network.

An issue may arise when a line is cut (broken, etc.). The resulting unusable line may be called a zombie line and/or zombie fiber. For example, the connection between circulator 330e and circulator 330h has been cut and the result is zombie fiber 342. The zombie fiber 342 may be detected when a signal is transmitted via one of circulator 330e and circulator 330h and the signal is not received at the other of circulator 330e and circulator 330h. The zombie fiber 342 may be detected when a signal is transmitted via one of circulator 330e and circulator 330h and the signal is received at the one of circulator 330e and circulator 330h. Because of the circulators 330a-i, signals of a same wavelength may be transmitted and received via a same fiber line.

An issue may arise when a line is connected to a first port, but never connected to a second port. The resulting line may be very small and hard to detect. When this happens, the resulting loose end of the fiber optic line may be called a zombie port. For example, when a signal (light, etc.) is transmitted from transmit port 310j through circulator 330e to the fiber 342, the signal may reflect off a damaged portion of the fiber 342 and return to the circulator 330e and be received at receive port 310i. If the signal received by the receive port 310i is relatively strong, then an assumption may be made that the line is very small and that one or both of transmit port 310j and receive port 310i are zombie ports.

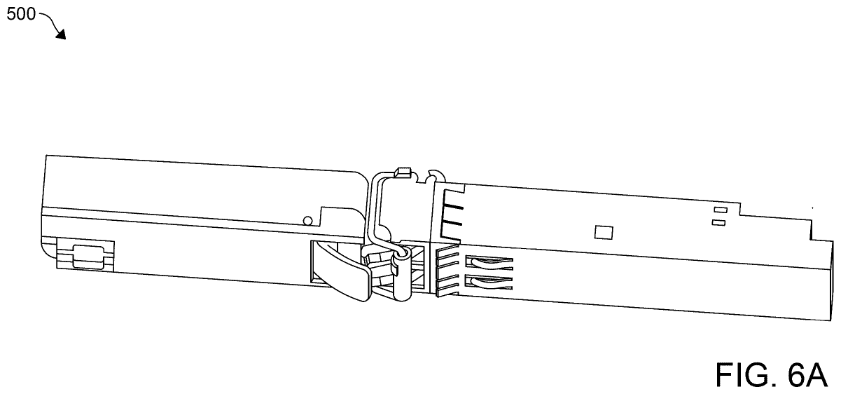

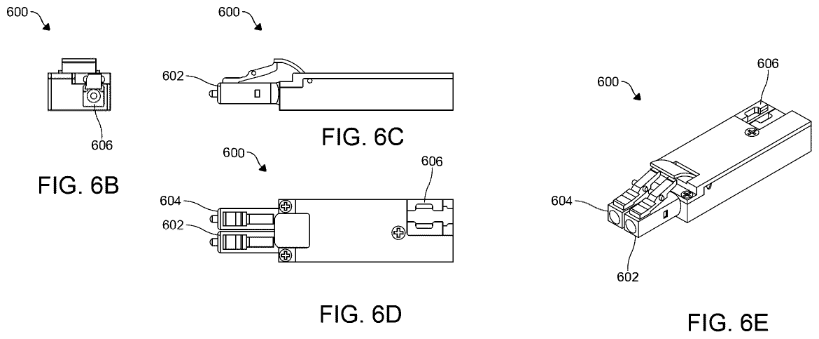

FIG. 4 shows an example device 430 configured to facilitate communication from a hub 400 via a fiber line 440 according to the systems and methods described herein. The example device 430 may comprise a transmit port coupler 432, a receive port coupler 434, a circulator 436, and a fiber line coupler 438. FIG. 6 shows a schematic of an example manufactured version (500) of the example device 430. FIG. 6 shows example schematic drawings of the example device 430. In FIG. 6, the example device 430 is labeled as 600, the transmit port coupler 432 is labeled as 602, the receiver port coupler 434 is labeled as 604, and the fiber line coupler 438 is labeled as 606. The example device 430 shown in FIGS. 4-6 will be explained with reference to FIG. 4. The example device 430 may comprise a small form-factor pluggable (SFP) design.

The transmit port coupler 432 may couple with a transmit port of a hub, such as the transmit port 410a of the hub 400. The transmit port coupler 432 may cause optical signals transmitted from the transmit port 410a to be transmitted to the circulator 436.

The receive port coupler 434 may couple with a receive port of a hub, such as the receive port 410b of the hub 400. The receive port coupler 434 may cause optical signals transmitted from the circulator 436 to be transmitted to the receive port 410b.

The circulator 436 may receive optical signals from the transmit port 410a and/or the transmit port coupler 432 and cause the optical signals received from the transmit port 410a and/or the transmit port coupler 432 to be transmitted to the fiber line 440 and/or the fiber line coupler 438. The circulator 436 may receive optical signals from the fiber line 440 and/or the fiber line coupler 438 and cause the optical signals received from the fiber line 440 and/or the fiber line coupler 438 to be transmitted to the receive port coupler 434 and/or the receive port 410b.

The fiber line coupler 438 may couple with a fiber line (cable, link, connection, path, etc.), such as the fiber line 440. The fiber line coupler 438 may cause optical signals transmitted from the circulator 436 to be transmitted to the fiber line 440. The fiber line coupler 438 may cause optical signals transmitted from the fiber line 440 to be transmitted to the circulator 436.

One or more processor(s) 450 of the hub 400 may cause transmit port 410a to transmit an optical signal. The optical signal may comprise a wavelength in a wavelength band. The wavelength band may comprise a wavelength comprising 1591 nanometers. The wavelength band comprises 1260 nm to 1625 nm, or 1565 nm to 1625 nm, or other optical bands such as optical communications bands (e.g., O-, E-, S-, C- and L-band). Other wavelengths and bands may be used.

The optical signal may comprise an indication of the source. The optical signal may comprise a unique signature. The optical signal may be encoded. The optical signal may be encrypted. The optical signal may comprise a time indicative of when the optical signal was transmitted from the transmit port 410a. The indication of the source may indicate that the optical signal was created at the hub 400 and transmitted from the transmit port 410a. The optical signal may transmit from the transmit port 410a and the transmit port coupler 432 and to the circulator 436. The circulator 436 may cause the optical signal to be transmitted to the fiber line coupler 438 and the fiber line 440. The optical signal may traverse the fiber line 440. The fiber line 440 may have been inadvertently cut, creating an unintended end. The optical signal may reflect off the unintended end and traverse the fiber line 440 back towards hub 400. The optical signal may be received from the fiber line 440 and the fiber line coupler 438 by the circulator 436. The circulator 436 may cause the optical signal to be transmitted to the receive port coupler 434 and the receive port 410b. The one or more processor(s) 450 may receive a signal indicative that the optical signal transmitted from the transmit port 410a was the same as the optical signal received at the receive port 410b. The one or more processor(s) 450 may receive signal data associated with the optical signal. Signal data may comprise the wavelength, the indication of the source, the unique signature, any type of encoding applied to the optical signal, any type of encryption applied to the optical signal, etc. . . . The one or more processor(s) 450 may determine that the optical signal transmitted from the transmit port 410a was the same as the optical signal received at the receive port 410b based on the signal data. The one or more processor(s) 450 may determine that the fiber line 440 is broken based on the signal indicative that the optical signal transmitted from the transmit port 410a was the same as the optical signal received at the receive port 410b. The one or more processor(s) 450 may determine a location (distance, etc.) where the fiber line 440 is broken relative to the hub 400 and/or the circulator and/or a transceiver comprising transmit port 410a and receive port 410b based on a difference in time between when the optical signal was transmitted from the transmit port 410a and when the optical signal was received at the receive port 410b. The one or more processor(s) 450 may cause signal data related to transmission of the optical signal, signal data related to reception of the optical signal, and/or any determinations made regarding the fiber line 440 to be transmitted to a centralized computing system via a transceiver 460. Determinations made regarding the fiber line 440 may be made by the centralized computing system 120. The centralized computing system may update a map of an optical network based on determinations made regarding the fiber line 440.

The one or more processor(s) 450 of the hub 400 may cause transmit port 410a to transmit an optical signal. The optical signal may comprise a wavelength in a wavelength band. The wavelength band may comprise a wavelength comprising 1591 nanometers. The wavelength band comprises 1260 nm to 1625 nm, or 1565 nm to 1625 nm, or other optical bands such as optical communications bands (e.g., O-, E-, S-, C- and L-band). Other wavelengths and bands may be used. The optical signal may comprise an indication of the source. The optical signal may comprise a unique signature. The optical signal may be encoded. The optical signal may be encrypted. The indication of the source may indicate that the optical signal was created at the hub 400 and transmitted from the transmit port 410a. The optical signal may transmit from the transmit port 410a and the transmit port coupler 432 and to the circulator 436. The circulator 436 may cause the optical signal to be transmitted to the fiber line coupler 438 and the fiber line 440. The optical signal may traverse the fiber line 440. The fiber line 440 may be connected to a second device, like the example device 430, at a second hub. The optical signal may be received from the fiber line 440 and a second fiber line coupler by a second circulator. The second circulator may cause the optical signal to be transmitted to a second receive port coupler and a second receive port. One or more second processor(s) associated with the second hub process signal data associated with the optical signal. Signal data may comprise the wavelength, the indication of the source, the unique signature, any type of encoding applied to the optical signal, any type of encryption applied to the optical signal, etc. The one or more second processor(s) may cause a second transmit port to transmit a second optical signal. The second optical signal may comprise the wavelength. The second optical signal may comprise an indication of the source. The indication of the source of the second optical signal may indicate that the second optical signal was created at the second hub and transmitted from the second transmit port. The second optical signal may comprise a unique signature. The second optical signal may be encoded. The second optical signal may be encrypted. The second optical signal may comprise a time indicative of when the optical signal was received at the second receive port. The second optical signal may comprise a time indicative of when the second optical signal was transmitted from the second transmit port. The second optical signal may be received from the fiber line 440 and the fiber line coupler 438 by the circulator 436. The circulator 436 may cause the second optical signal to be transmitted to the receive port coupler 434 and the receive port 410b. The one or more processor(s) 450 may receive a signal indicative of signal data related to the second optical signal. Signal data may comprise the wavelength, the indication of the source, the unique signature, any type of encoding applied to the optical signal, any type of encryption applied to the optical signal, etc. . . . The one or more processor(s) 450 and/or the one or more second processor(s) may determine that the transmit port 410a and the receive port 410b of the hub 400 are connected to the second receive port and the second transmit port of the second hub via the fiber line 440. The one or more processor(s) 450 and/or the one or more second processor(s) may determine a distance between the hub 400 and the second hub based on one or more transmission times. The one or more processor(s) 450 and/or the one or more second processor(s) may determine a latency between the hub 400 and the second hub via the fiber line 440 based on one or more transmission times and/or the determined distance. The one or more processor(s) 450 may cause signal data related to transmission of the optical signal, signal data related to reception of the second optical signal, any determinations made regarding the second hub, and/or any determinations made regarding the fiber line 440 to be transmitted to a centralized computing system via the transceiver 460. The one or more second processor(s) may cause signal data related to reception of the optical signal, signal data related to transmission of the second optical signal, any determinations made regarding the hub 400, and/or any determinations made regarding the fiber line 440 to be transmitted to a centralized computing system via a second transceiver. Determinations made regarding the hub 400, the second hub, and/or the fiber line 440 may be made by the centralized computing system. The centralized computing system may update a map of an optical network based on determinations made regarding the hub 400, the second hub, and/or the fiber line 440.

The one or more processor(s) 450 of the hub 400 may cause transmit port 410a to transmit an optical signal. The optical signal may comprise a wavelength in a wavelength band. The wavelength band may comprise a wavelength comprising 1591 nanometers. The wavelength band comprises 1260 nm to 1625 nm, or 1565nm to 1625nm, or other optical bands such as optical communications bands (e.g., O-, E-, S-, C- and L-band). Other wavelengths and bands may be used. The optical signal may comprise an indication of the source. The optical signal may comprise a unique signature. The optical signal may be encoded. The optical signal may be encrypted. The optical signal may comprise a time indicative of when the optical signal was transmitted from the transmit port 410a. The indication of the source may indicate that the optical signal was created at hub 400 and transmitted from transmit port 410a. The optical signal may transmit from the transmit port 410a and the transmit port coupler 432 and to the circulator 436. The circulator 436 may cause the optical signal to be transmitted to the fiber line coupler 438 and the fiber line 440. The optical signal may traverse the fiber line 440. The fiber line 440 may be in communication with a foreign (alien, unknown, etc.) port. The fiber line 440 may have never been connected to a second port. The one or more processor(s) 450 may cause signal data related to transmission of the optical signal on the fiber line 440 to be transmitted to a centralized computing system via the transceiver 460. The centralized computing system may determine that the optical signal is not received at any port in the optical network. The centralized computing system may determine that the fiber line 440 comprises an alien port and/or a zombie port. After a predetermined time, the one or more processor(s) 450 may determine that no return signal was received from a second hub in response to the optical signal, the optical signal was not received at another port at the hub 400, and that the optical signal did not return via a reflection in the fiber line 440. The one or more processor(s) 450 may, based on the determination that no return signal was received from a second hub in response to the optical signal, the optical signal was not received at another port at the hub 400, and that the optical signal did not return via a reflection in the fiber line 440 after the predetermined time, determine that the fiber line 440 comprises an alien port and/or zombie port. The one or more processor(s) 450 may cause any determination regarding transmission of the optical signal and/or the fiber line 440 to be transmitted to a centralized computing system via the transceiver 460. The centralized computing system may update a map of an optical network based on determinations made regarding the fiber line 440.

The transceiver 460 may be an optical transceiver. The transceiver 460 may be in communication with a cellular network. The transceiver 460 may be in communication with a satellite network.

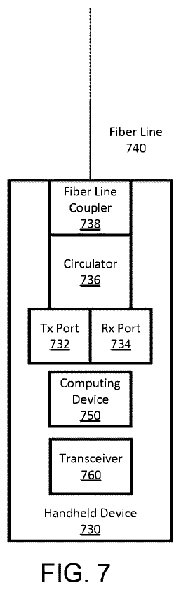

FIG. 7 shows an example handheld device 730 configured to facilitate communication via a fiber line 740 according to the systems and methods described herein. The handheld device 730 comprises a transmit port 732, a receive port 734, a circulator 736, a fiber line coupler 738, a computing device 750, and a transceiver 760.

The transmit port 732 may cause optical signals created by the handheld device 730 to be transmitted to the circulator 736. The receive port 734 may receive optical signals transmitted from the fiber line 740 via the circulator 736.

The circulator 736 may receive optical signals from the transmit port 732 and cause the optical signals received from the transmit port 732 to be transmitted to the fiber line 740 and/or the fiber line coupler 738. The circulator 736 may receive optical signals from the fiber line 740 and/or the fiber line coupler 738 and cause the optical signals received from the fiber line 740 and/or the fiber line coupler 738 to be transmitted to the receive port 734.

The fiber line coupler 738 may couple with a fiber line (cable, link, connection, path, etc.), such as the fiber line 740. The fiber line coupler 738 may cause optical signals transmitted from the circulator 736 to be transmitted to the fiber line 740. The fiber line coupler 738 may cause optical signals transmitted from the fiber line 740 to be transmitted to the circulator 736.

The computing device 750 may cause the transmit port 732 to transmit optical signals. The computing device 750 may process signal data from optical signals received at the receive port 734. The computing device 750 may cause signal data and/or determinations made regarding signal data and/or fiber lines, such as the fiber line 740, to a centralized computing system via the transceiver 760.

The handheld device 730 may operate similarly to the example device 430 in FIG. 4 coupled to ports of the hub 400. The handheld device 730 may allow upstream and downstream communication over a single fiber line using optical signals comprising a same wavelength. The handheld device 730 may attach to a fiber line in an optical network and receive communication from the example device 430 via the fiber line and send communication to the example device 430 via the fiber line. The handheld device 730 may communicate results to a centralized computing system via the transceiver. The handheld device 730 may also communicate location information, such as global positioning system (GPS) coordinates to the centralized computing system via the transceiver. For example, the hub 400, using the example device 430, discovers that the fiber line 440 is cut, an operator may go to a determined location. If the operator finds a fiber and couples the handheld device 730 to the found fiber, then the hub 400 may cause an optical signal to be transmitted via the fiber line 440 to determine if the found fiber is the fiber line 440. If the handheld device 730 receives the transmitted optical signal, then the transceiver may cause an indication that the fiber line 440 is terminated at the location of the handheld device 730 to the centralized computing system. The centralized computing system may update a map of an optical network based on determinations made regarding information received from the handheld device 730, including termination points for issues such as zombie fibers, zombie ports, alien ports, etc.

The transceiver 760 may be an optical transceiver. The transceiver 760 may be in communication with a cellular network. The transceiver 760 may be in communication with a satellite network. The transceiver 760 may be in communication with an ethernet network. The transceiver 760 may be in communication with a Data Over Cable Service Interface Specifications (DOCSIS) network. The transceiver 760 may be in communication with the centralized computing system.

The handheld device 730 may comprise a meter. The handheld device 730 may be configured to perform other utility optical measurements and/or test functions. The handheld device 730 may be configured to communicate signal information (light power levels, identifier, signal characteristics, etc.) to the centralized computer.

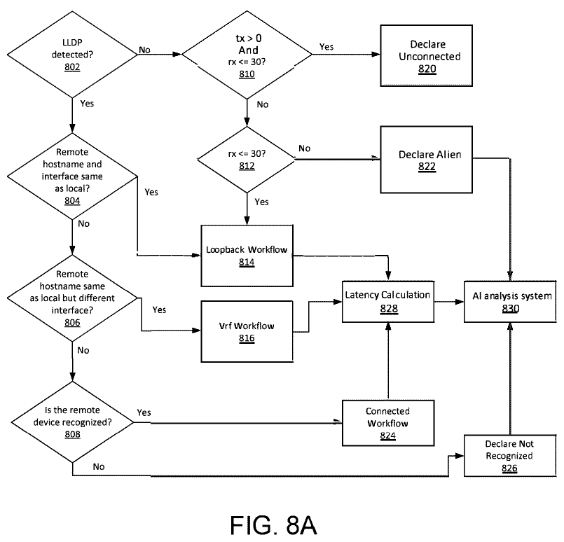

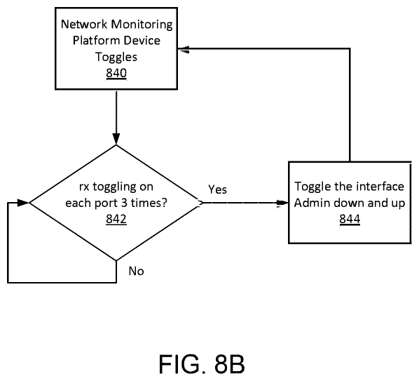

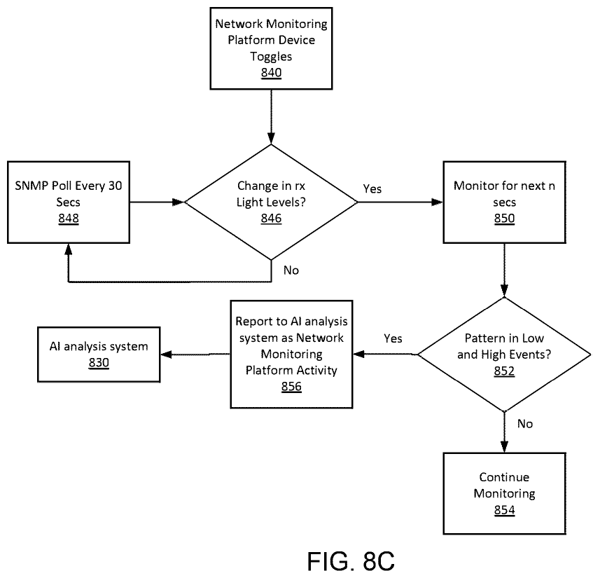

FIGS. 8A-8C show an example flow diagram of an example method described herein. The example method may execute in response to receiving an optical signal. At step 802, a determination may be made of if link layer discovery protocol (LLDP) is detected in the optical signal. If LLDP is detected in the optical signal, then the method may advance to step 804. If LLDP is not detected in the optical signal, then the method may advance to step 810.

At step 804, a determination may be made of if a hostname and interface associated with the optical signal (remote hostname and interface) are the same as a local hostname and interface. If the remote hostname and interface are determined to be the same as the local hostname and interface, then the method may advance to step 814. If the remote hostname and interface are determined to be not the same as the local hostname and interface, then the method may advance to step 806.

At step 806, a determination may be made of if the remote hostname is the same as the local hostname, but the remote interface is different from the local interface. If a determination is made that the remote hostname is the same as the local hostname, but the remote interface is different from the local interface, then the method may advance to step 816. If a determination is made that the remote hostname is different from the local hostname, and/or that the remote interface is the same as the local interface, then the method may advance to step 808.

At step 808, the remote hostname and the local hostname are different. A determination may be made of if a remote device associated with the remote hostname is recognized. If the remote device is determined to be recognized, then the method may advance to step 824. If the remote device is determined to not be recognized, then the method may advance to step 826.

At step 810, a determination may be made of if a transmit power value satisfies a transmit power threshold and a receive power value satisfies a receive power threshold. The transmit power threshold may be, for example, zero decibel milliwatts (dBm). As a further example, the transmit power value may satisfy the transmit power threshold if the transmit power value is greater than the transmit power value. The receive power threshold may be, for example, negative thirty decibel milliwatts (dBm). As a further example, the receive power value may satisfy the receive power threshold if the receive power value is greater than negative thirty dBm. If a determination is made that the transmit power value satisfies the transmit power threshold and the receive power value satisfies the receive power threshold, then the method may advance to step 820. If a determination is made that the transmit power value does not satisfy the transmit power threshold, and/or the receive power value does not satisfy the receive power threshold, then the method may advance to step 812.

At step 812, a determination may be made of it the receive power value satisfies the receive power threshold. If a determination is made that the receive power value satisfies the receive power threshold, then the method may advance to step 814. If a determination is made that the receive power value does not satisfy the receive power threshold, then the method may advance to step 822.

At step 814, a loopback workflow may be executed. The loopback workflow may execute a local ping command using information from data from the optical signal and measure a latency time associated with the local ping command. Latency measurements may be taken multiple times. If a signal is received at a receive port, and LLDP information associated with the signal indicates that the signal was transmitted from a neighboring port, then the receive port, the neighboring port, and/or a path between the receive port and the neighboring port may be classified as loopback with fiber (LLDP, etc.) information. The neighboring port may be a transmit port that shares a non-reciprocal optical material or device (circulator, etc.) with the receive port.

If an indication that a receive port is receiving light (data, signals, information, etc.) is active, but the indication deactivates in response to a neighboring transmit port being ceasing to transmit light, then the receive port, the neighboring transmit port, and/or a path between the receive port and the neighboring transmit port may be classified as loopback without fiber information. The neighboring transmit port may be a transmit port that shares a non-reciprocal optical material or device (circulator, etc.) with the receive port. The method may advance to step 828, where the measured latency and corresponding data from the optical signal are provided to a data structure and/or memory used to store latency calculations.

At step 816, a virtual routing and forwarding (vrf) workflow may be executed. The vrf workflow may execute a ping command using information from data from the optical signal and measure a latency time associated with the ping command. Latency measurements may be taken multiple times. A vrf may be used to overcome a logical loopback. If a hub detects that a signal is being transmitted locally, then the hub may automatically cause the receive port to receive the signal without transmitting the signal on an associated fiber line. Using vrf, a determination may be made if a receive port associated with the routing device (router, switch, hub, etc.) transmits a signal to a transmit port associated with the routing device. If such a determination is made, then the receive port, the transmit port, and/or a path between the receive port and the transmit port may be classified as connected locally. The method may advance to step 828, where the measured latency and corresponding data from the optical signal are provided to a data structure and/or memory used to store latency calculations.

At step 820, a fiber line and/or receive port associated with the optical signal may be declared unconnected.

At step 822, a fiber line associated with the optical signal may be declared alien. The method may then advance to step 830.

At step 824, a connected workflow may be executed. The connected workflow may execute a ping command using information from data from the optical signal and measure a latency time associated with the ping command. If a signal is transmitted from a transmit port at a first hub and the signal is received at a receive port at a second hub, then the transmit port, the receive port, and/or a path between the transmit port and the receive port may be classified as connected. Latency measurements may be taken multiple times. The method may advance to step 828, where the measured latency and corresponding data from the optical signal are provided to a data structure and/or memory used to store latency calculations.

At step 826, a fiber line associated with the optical signal may be declared as not recognized. The method may then advance to step 830.

At step 828, latency information may be collected and organized. When multiple latencies are given for a path, data, such as maximum, minimum, average, standard deviation, etc. may be calculated for the path. The method may then advance to step 830.

At step 830, a machine learning (ML) analysis system may be used to analyze data provided. Information, such as documentation (e.g., data store, repository, maps, visualizations, tables, or the like). associated with a fiber network may be updated provided by the ML analysis system. Recommendations for service repairs, connections, network maintenance, etc. may be made provided by the ML analysis system.

At step 840, a network monitoring platform device may modulate (toggle, adjust, etc.) the light signal to identify the system light to differentiate from an alien wavelength. The method may advance to step 842 and/or step 846.

At step 842, a determination may be made of if a receive power has been adjusted on a receive port a predetermined number of times. Adjusting the receive power may comprise toggling the receive power from any external source, such as a handheld optical device, such as the handheld device described in FIG. 7. The predetermined number may be, for example, 3. If it is determined that the receive power has not been adjusted on the receive port the predetermined number of times, then the method may stay at step 842. The receive power may be adjusted on the receive port. Although the matching of a receive port with a transmit port was described in regards to matching a number of times a receive power was adjusted, other values, such as a rate that the receive power was adjusted, may be used. If it is determined that the receive power has been adjusted on the receive port the predetermined number of times, then the method may advance to step 844.

At step 844, the interface administrator may be adjusted up and/or down as an acknowledgement to the platform that the receiver has detected the system communication. Adjusting the interface may comprise toggling the interface. The method may return to step 840.

At step 846, a determination may be made if a change in receive power light levels is detected. If no change in receive power light levels is detected, then the method may advance to step 848. If a change in receive power light levels is detected, then the method may advance to step 850.

At step 848, a simple network management protocol (SNMP) poll may be initiated at an interval. The interval may be, for example, 30 seconds. The SNMP poll may set a level associated with a laser associated with a transmit port. The SNMP poll may control a state associated with the laser. The method may return to step 846.

At step 850, the device adjusted at step 840 may be monitored for a predetermined amount of time to watch for the indication light level modulation. After the predetermined amount of time, the method may advance to step 852.

At step 852, a determination may be made of if a pattern in low and/or high events emerges. If a pattern in low and/or high event does not emerge, then the method may advance to step 854. If a pattern in low and/or high event emerges, then the method may advance to step 856.

At step 854, the device adjusted at step 840 may continue to be monitored.

At step 856, the patterns in low and/or high events observed in the device adjusted in step 840 may be provided to a network monitoring platform. The patterns in low and/or high events observed in the device adjusted in step 840 may be provided to the ML analysis system. The method may advance to step 830.

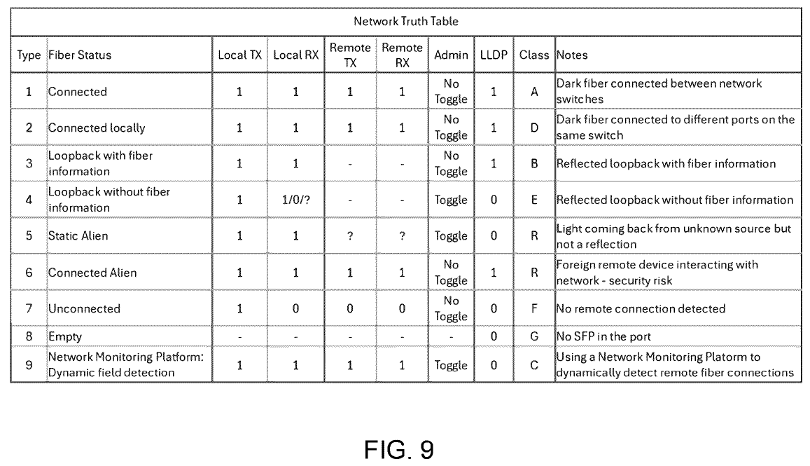

FIG. 9 shows an example truth table associating attributes with a fiber status according to the systems and methods described herein. The truth table assigns a type (sequential number) to each fiber status. The attributes associated with the fiber statuses are a Boolean value indicating if a local transmit port is operational, a Boolean value indicating if a local receive port is operational, a Boolean value indicating if a remote transmit port is operational, a Boolean value indicating if a remote receive port is operational, a state status indicating if an administrator has adjusted (modulated, toggled, etc.) an associated device, a Boolean value indicating if link layer discovery protocol (LLDP) is detected on an associated fiber path (line, link, cable, connection, etc.), a class (priority, etc.) assigned to the fiber status, and notes associated with the fiber status.

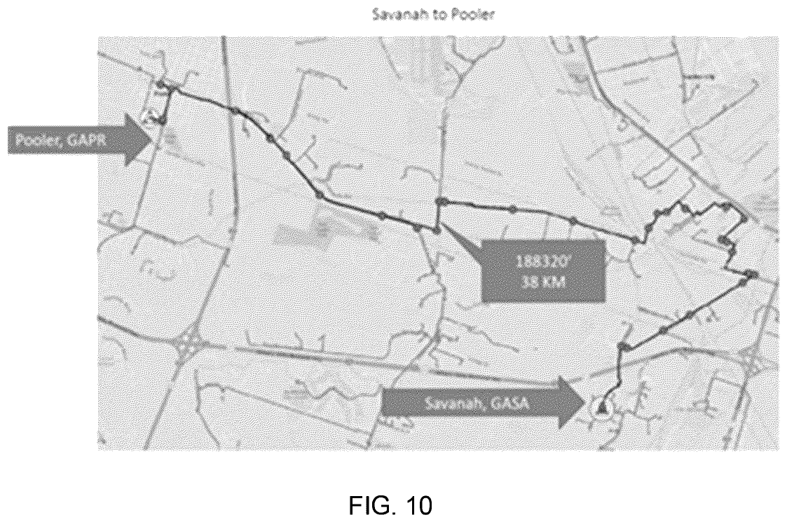

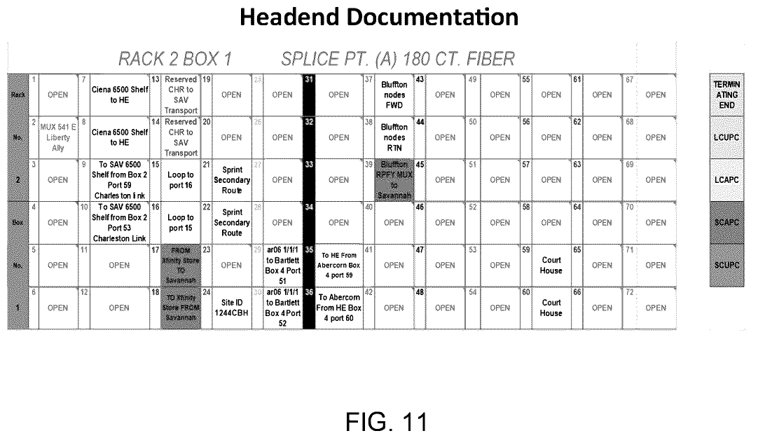

Example output generated by the systems and methods of the present disclosure may comprise visualizations of data and patterns based on optical signal data such as power levels, laser status of a small form-factor pluggable (SFP), and/or latency or distance statistics for one or more receive port and/or one or more transmit port. Other data points and metrics may be used. Connections between hubs may be visualized via an output to establish accurate and timely connectivity state for fiber in a specific hub or between a set of hubs represented in the columns and rows for a certain market area shown in the map. A variety of reporting, searching, and/or other database functionality is available to provide custom analytics on fiber availability, performance status, and network state. FIGS. 10-11 show example images of output associated with the systems and methods described herein. FIG. 10 shows an example mapping of a connection between two hubs. Measured distances may be correlated with existing network documentation systems to update distances and lengths to represent actual network status, or identify network facility locations, or fiber management locations not accurately represented in construction documentation. FIG. 11 shows example documentation automatically created by the systems and methods described herein. As shown, mapping and connection details may be discovered, monitored, and updated, and may be displayed for a user. The present systems and methods may provide discovery tools to detect dark fibers or other fiber characteristics not currently available.

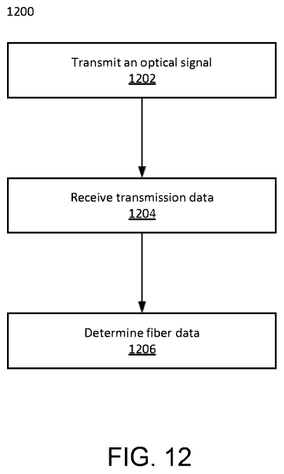

FIG. 12 is a flowchart of an example process 1200. In some implementations, one or more process blocks of FIG. 12 may be performed by the centralized computing system 120 in FIG. 1, one of the hubs in FIG. 1, and/or the one or more processor(s) 450 in FIG. 4.

As shown in FIG. 12, process 1200 may include transmitting an optical signal (block 1202). For example, the centralized computing system 120 in FIG. 1 may transmit an optical signal. As another example, hub 100a in FIG. 1 may transmit an optical signal. As another example, the one or more processor(s) 450 in FIG. 4 may transmit an optical signal. The optical signal may be transmitted via an optical fiber. The optical signal may be transmitted via an optical circulator coupled to an optical transceiver. The optical signal may comprise a wavelength in a wavelength band. The wavelength band may comprise a wavelength comprising 1591 nanometers. The wavelength band comprises 1260 nm to 1625 nm, or 1565 nm to 1625 nm, or other optical bands such as optical communications bands (e.g., O-, E-, S-, C- and L-band). Other wavelengths and bands may be used.

As also shown in FIG. 12, process 1200 may include receiving transmission data (block 1204). For example, the centralized computing system 120 in FIG. 1 may receive transmission data. As another example, hub 100a in FIG. 1 may receive transmission data. As another example, the one or more processor(s) 450 in FIG. 4 may receive transmission data. The transmission data may be indicative of reception or loss of the optical signal via the optical fiber.

As further shown in FIG. 12, process 1200 may include determining fiber data (block 1206). For example, the centralized computing system 120 in FIG. 1 may determine fiber data. As another example, hub 100a in FIG. 1 may determine fiber data. As another example, the one or more processor(s) 450 in FIG. 4 may determine fiber data. The fiber data may be determined based on at least the transmission data. The fiber data may be indictive of at least a condition of the optical fiber.

Process 1200 may include receiving, via the optical fiber and the optical circulator coupled to the optical transceiver, the optical signal. For example, the centralized computing system 120 in FIG. 1 may receive, via the optical fiber and the optical circulator coupled to the optical transceiver, the optical signal. As another example, hub 100a in FIG. 1 may receive, via the optical fiber and the optical circulator coupled to the optical transceiver, the optical signal. As another example, the one or more processor(s) 450 in FIG. 4 may receive, via the optical fiber and the optical circulator coupled to the optical transceiver, the optical signal. The determining fiber data indicative of at least a condition of the optical fiber may comprise determining a defect in the optical fiber based on the receiving the optical signal via the optical fiber and the optical circulator coupled to the optical transceiver.

Process 1200 may include determining a location of the defect in the optical fiber based on a difference in time between the receiving the optical signal and the transmitting the optical signal. For example, the centralized computing system 120 in FIG. 1 may determine a location of the defect in the optical fiber based on a difference in time between the receiving the optical signal and the transmitting the optical signal. As another example, hub 100a in FIG. 1 may determine a location of the defect in the optical fiber based on a difference in time between the receiving the optical signal and the transmitting the optical signal. As another example, the one or more processor(s) 450 in FIG. 4 may determine a location of the defect in the optical fiber based on a difference in time between the receiving the optical signal and the transmitting the optical signal.

Process 1200 may include causing an operator to be dispatched to the location. For example, the centralized computing system 120 in FIG. 1 may cause an operator to be dispatched to the location. As another example, hub 100a in FIG. 1 may cause an operator to be dispatched to the location. As another example, the one or more processor(s) 450 in FIG. 4 may cause an operator to be dispatched to the location. The operator may be in possession of a handheld device, such as the handheld device 730 in FIG. 7. The handheld device may comprise a second optical circulator coupled to a second optical transceiver. The handheld device may be coupled to the optical fiber at the location.

Process 1200 may include transmitting, via the optical fiber and the optical circulator coupled to the optical transceiver, a second optical signal. For example, the centralized computing system 120 in FIG. 1 may transmit, via the optical fiber and the optical circulator coupled to the optical transceiver, a second optical signal. As another example, hub 100a in FIG. 1 may transmit, via the optical fiber and the optical circulator coupled to the optical transceiver, a second optical signal. As another example, the one or more processor(s) 450 in FIG. 4 may transmit, via the optical fiber and the optical circulator coupled to the optical transceiver, a second optical signal. Process 1200 may include receiving, via the optical fiber and the optical circulator coupled to the optical transceiver, a response signal. For example, the centralized computing system 120 in FIG. 1 may receive, via the optical fiber and the optical circulator coupled to the optical transceiver, a response signal. As another example, hub 100a in FIG. 1 may receive, via the optical fiber and the optical circulator coupled to the optical transceiver, a response signal. As another example, the one or more processor(s) 450 in FIG. 4 may receive, via the optical fiber and the optical circulator coupled to the optical transceiver, a response signal. The response signal may be generated by the handheld device in response to the second optical signal.

Process 1200 may include receiving, via the optical fiber and the optical circulator coupled to the optical transceiver, a second optical signal. For example, the centralized computing system 120 in FIG. 1 may receive, via the optical fiber and the optical circulator coupled to the optical transceiver, a second optical signal. As another example, hub 100a in FIG. 1 may receive, via the optical fiber and the optical circulator coupled to the optical transceiver, a second optical signal. As another example, the one or more processor(s) 450 in FIG. 4 may receive, via the optical fiber and the optical circulator coupled to the optical transceiver, a second optical signal. The second optical signal may be generated by the handheld device. Process 1200 may include transmitting, via the optical fiber and the optical circulator coupled to the optical transceiver, a response signal. For example, the centralized computing system 120 in FIG. 1 may transmit, via the optical fiber and the optical circulator coupled to the optical transceiver, a response signal. As another example, hub 100a in FIG. 1 may transmit, via the optical fiber and the optical circulator coupled to the optical transceiver, a response signal. As another example, the one or more processor(s) 450 in FIG. 4 may transmit, via the optical fiber and the optical circulator coupled to the optical transceiver, a response signal. The response signal may be generated in response to the second optical signal.

Documentation associated with the optical fiber may be automatically updated to indicate that the optical fiber has the defect. The documentation associated with the optical fiber may be automatically updated to indicate the location of the defect. A mapping associated with the optical fiber may be automatically updated to indicate that the optical fiber has the defect. The mapping associated with the optical fiber may be automatically updated to indicate the location of the defect. The defect may comprise at least one of: an aperture, a bend, and a complete separation.

Process 1200 may comprise receiving, via the optical fiber and the optical circulator coupled to the optical transceiver, a second optical signal. For example, the centralized computing system 120 in FIG. 1 may receive, via the optical fiber and the optical circulator coupled to the optical transceiver, a second optical signal. As another example, hub 100a in FIG. 1 may receive, via the optical fiber and the optical circulator coupled to the optical transceiver, a second optical signal. As another example, the one or more processor(s) 450 in FIG. 4 may receive, via the optical fiber and the optical circulator coupled to the optical transceiver, a second optical signal. The second optical signal may comprise signal data.

The signal data may comprise data indicative of a source of the second optical signal. The source may comprise one or more of a hub, switch, and port based on the signal data. A distance to the source via the optical fiber may be determined based on a difference between a time associated with the receiving the second optical signal and the transmitting the (first) optical signal. A latency associated with the source via the optical fiber may be determined based on a difference between a time associated with the receiving the second optical signal and the transmitting the (first) optical signal.

Documentation associated with the optical fiber may be automatically updated to indicate that the optical fiber is connected to the source. The documentation associated with the optical fiber may be automatically updated to indicate the latency associated with the source via the optical fiber. A mapping associated with the optical fiber may be automatically updated to indicate that the optical fiber is connected to the source. The mapping associated with the optical fiber may be automatically updated to indicate the latency associated with the source via the optical fiber.

The transmission data may indicate loss of the optical signal via the optical fiber. Documentation associated with the optical fiber may be automatically updated to indicate that the optical fiber is connected to an unknown port.

A mapping associated with the optical fiber may be automatically updated to indicate that the optical fiber is connected to an unknown port.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

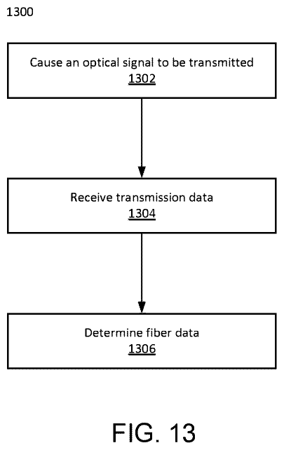

FIG. 13 is a flowchart of an example process 1300. In some implementations, one or more process blocks of FIG. 13 may be performed by the centralized computing system 120 in FIG. 1 and/or the one or more processor(s) 450 in FIG. 4.

As shown in FIG. 13, process 1300 may include causing an optical signal to be transmitted (block 1302). For example, the centralized computing system 120 in FIG. 1 may cause an optical signal to be transmitted. As another example, the one or more processor(s) 450 in FIG. 4 may cause an optical signal to be transmitted. The optical signal may be transmitted at a first hub. The optical signal may be transmitted via an optical fiber. The optical signal may be transmitted via a first optical circulator coupled to a first optical transceiver. The optical signal may be transmitted for reception by a second optical circulator coupled to a second optical transceiver. The second optical circulator and the second optical transceiver may be located at the first hub. The second optical circulator and the second optical transceiver may be located at a second hub. The second hub may be different from the first hub. The optical signal may comprise a wavelength in a wavelength band. The wavelength band may comprise a wavelength comprising 1591 nanometers. The wavelength band comprises 1260 nm to 1625 nm, or 1565 nm to 1625 nm, or other optical bands such as optical communications bands (e.g., O-, E-, S-, C- and L-band). Other wavelengths and bands may be used.

As also shown in FIG. 13, process 1300 may include receiving transmission data (block 1304). For example, the centralized computing system 120 in FIG. 1 may receive transmission data. As another example, the one or more processor(s) 450 in FIG. 4 may receive transmission data. The transmission data may be indicative of reception or loss of the optical signal via the optical fiber. The transmission data may comprise local data. The transmission data may comprise an indication of reception of the optical signal by the second optical circulator coupled to the second optical transceiver. The transmission data may comprise an indication of reception of the optical signal by the first optical circulator coupled to the first optical transceiver.

As further shown in FIG. 13, process 1300 may include determining fiber data (block 1306). For example, the centralized computing system 120 in FIG. 1 may determine fiber data. As another example, the one or more processor(s) 450 in FIG. 4 may determine fiber data. The fiber data may be determined based on at least the transmission data. The fiber data may be indictive of at least a condition of the optical fiber. The determining fiber data indicative of at least a condition of the optical fiber may comprise determining a defect in the optical fiber based on the reception of the optical signal by the first optical circulator coupled to the first optical transceiver.

Documentation associated with the optical fiber may be automatically updated to indicate that the optical fiber connects one or more of: the first hub and the second hub; and the first optical transceiver and the second optical transceiver. A mapping associated with the optical fiber may be automatically updated to indicate that the optical fiber connects one or more of: the first hub and the second hub; and the first optical transceiver and the second optical transceiver.

A time to travel may be determined by a difference between a time associated the reception of the optical signal and a time associated with the causing the optical signal to be transmitted. Documentation associated with the optical fiber may be automatically updated to indicate a distance, via the optical fiber, between one or more of: the first hub and the second hub; and the first optical transceiver and the second optical transceiver. A mapping associated with the optical fiber may be automatically updated to indicate a distance, via the optical fiber, between one or more of: the first hub and the second hub; and the first optical transceiver and the second optical transceiver.

A latency may be determined by a difference between a time associated the reception of the optical signal and a time associated with the causing the optical signal to be transmitted. Documentation associated with the optical fiber may be automatically updated to indicate the latency, via the optical fiber, between one or more of: the first hub and the second hub; and the first optical transceiver and the second optical transceiver. A mapping associated with the optical fiber may be automatically updated to indicate the latency, via the optical fiber, between one or more of: the first hub and the second hub; and the first optical transceiver and the second optical transceiver.

Process 1300 may include determining a location of the defect in the optical fiber based on a difference between a time associated the reception of the optical signal and a time associated with the causing the optical signal to be transmitted. For example, the centralized computing system 120 in FIG. 1 may determine a location of the defect in the optical fiber based on a difference between a time associated the reception of the optical signal and a time associated with the causing the optical signal to be transmitted. As another example, the one or more processor(s) 450 in FIG. 4 may determine a location of the defect in the optical fiber based on a difference between a time associated the reception of the optical signal and a time associated with the causing the optical signal to be transmitted. Documentation associated with the optical fiber may be automatically updated to indicate that the optical fiber has the defect. The documentation associated with the optical fiber may be automatically updated to indicate the location of the defect. A mapping associated with the optical fiber may be automatically updated to indicate that the optical fiber has the defect. The mapping associated with the optical fiber may be automatically updated to indicate the location of the defect. The defect may comprise at least one of: an aperture, a bend, and a complete separation.

Although FIG. 13 shows example blocks of process 1300, in some implementations, process 1300 may include additional blocks, fewer blocks, different blocks, or differently arranged blocks than those depicted in FIG. 13. Additionally, or alternatively, two or more of the blocks of process 1300 may be performed in parallel.

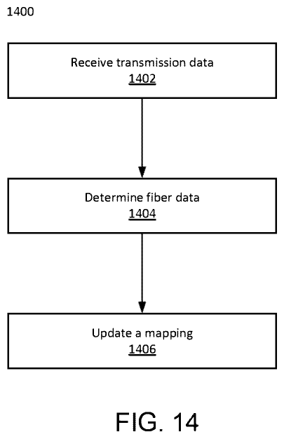

FIG. 14 is a flowchart of an example process 1400. In some implementations, one or more process blocks of FIG. 14 may be performed by the centralized computing system 120 in FIG. 1 and/or the one or more processor(s) 450 in FIG. 4.

As shown in FIG. 14, process 1400 may include receiving transmission data (block 1402). For example, the centralized computing system 120 in FIG. 1 may receive transmission data. As another example, the one or more processor(s) 450 in FIG. 4 may receive transmission data. The transmission data may be indicative of reception or loss of an optical signal via an optical fiber. The optical signal may have been transmitted via the optical fiber. The optical signal may have been transmitted via a first optical circulator coupled to a first optical transceiver. The optical signal may have been transmitted at a first hub. The optical signal may have been transmitted for reception by a second optical circulator coupled to a second optical transceiver. The second optical circulator and the second optical transceiver may be located at the first hub. The transmission data may comprise local data. The second optical circulator and the second optical transceiver may be located at a second hub. The second hub may be different from the first hub. The transmission data may comprise an indication of reception of the optical signal by the second optical circulator coupled to the second optical transceiver. The transmission data may comprise an indication of the optical signal being transmitted via the first optical circulator coupled to the first optical transceiver at a first time. The transmission data may comprise an indication of the reception of the optical signal at a second time. The transmission data may comprise an indication of reception of the optical signal by the first optical circulator coupled to the first optical transceiver. The optical signal may comprise a wavelength in a wavelength band. The wavelength band may comprise a wavelength comprising 1591 nanometers. The wavelength band comprises 1260 nm to 1625 nm, or 1565 nm to 1625 nm, or other optical bands such as optical communications bands (e.g., O-, E-, S-, C- and L-band). Other wavelengths and bands may be used.

As also shown in FIG. 14, process 1400 may include determining fiber data (block 1404). For example, the centralized computing system 120 in FIG. 1 may determine fiber data. As another example, the one or more processor(s) 450 in FIG. 4 may determine fiber data. The fiber data may be determined based on at least the transmission data. The fiber data may be indictive of at least a condition of the optical fiber. The determining fiber data indicative of at least a condition of the optical fiber may comprise determining a defect in the optical fiber based on the reception of the optical signal by the first optical circulator coupled to the first optical transceiver. The defect may comprise at least one of: an aperture, a bend, and a complete separation.

As further shown in FIG. 14, process 1400 may include updating a mapping (block 1406). For example, the centralized computing system 120 in FIG. 1 may update a mapping. As another example, the one or more processor(s) 450 in FIG. 4 may update a mapping. The mapping may be associated with the optical fiber. The updating the mapping may be based on at least the fiber data.

Documentation associated with the optical fiber may be automatically updated to indicate that the optical fiber connects one or more of: the first hub and the second hub; and the first optical transceiver and the second optical transceiver. The updating a mapping associated with the optical fiber based on at least the fiber data may comprise automatically updating the mapping associated with the optical fiber to indicate that the optical fiber connects one or more of: the first hub and the second hub; and the first optical transceiver and the second optical transceiver.

A time to travel may be determined by a difference between the second time and the first time. Documentation associated with the optical fiber may be automatically updated to indicate a distance, via the optical fiber and based on the time to travel, between one or more of: the first hub and the second hub; and the first optical transceiver and the second optical transceiver. The updating a mapping associated with the optical fiber based on at least the fiber data may comprise automatically updating the mapping associated with the optical fiber to indicate a distance, via the optical fiber and based on the time to travel, between one or more of: the first hub and the second hub; and the first optical transceiver and the second optical transceiver.

A latency may be determined by a difference between the second time and the first time. Documentation associated with the optical fiber may be automatically updated to indicate the latency, via the optical fiber, between one or more of: the first hub and the second hub; and the first optical transceiver and the second optical transceiver. The updating a mapping associated with the optical fiber based on at least the fiber data may comprise automatically updating a mapping associated with the optical fiber to indicate the latency, via the optical fiber, between one or more of: the first hub and the second hub; and the first optical transceiver and the second optical transceiver.

Process 1400 may include determining a location of the defect in the optical fiber based on a difference between the second time and the first time. For example, the centralized computing system 120 in FIG. 1 may determine a location of the defect in the optical fiber based on a difference between the second time and the first time. As another example, the one or more processor(s) 450 in FIG. 4 may determine a location of the defect in the optical fiber based on a difference between the second time and the first time. Documentation associated with the optical fiber may be automatically updated to indicate that the optical fiber has the defect. The documentation associated with the optical fiber may be automatically updated to indicate the location of the defect. The updating a mapping associated with the optical fiber based on at least the fiber data may comprise automatically updating a mapping associated with the optical fiber to indicate that the optical fiber has the defect. The mapping associated with the optical fiber may be automatically updated to indicate the location of the defect.

Although FIG. 14 shows example blocks of process 1400, in some implementations, process 1400 may include additional blocks, fewer blocks, different blocks, or differently arranged blocks than those depicted in FIG. 14. Additionally, or alternatively, two or more of the blocks of process 1400 may be performed in parallel.

Example Clause 1: A method may include: transmitting, via an optical fiber and an optical circulator coupled to an optical transceiver, an optical signal; receiving transmission data indicative of reception or loss of the optical signal via the optical fiber; and determining, based on at least the transmission data, fiber data indictive of at least a condition of the optical fiber.

Example Clause 2: The method of Example Clause 1, where the optical signal may include a wavelength in a wavelength band, and where the wavelength band may include a 1591 nanometer wavelength. The wavelength band comprises 1260 nm to 1625 nm, or 1565 nm to 1625 nm, or other optical bands such as optical communications bands (e.g., O-, E-, S-, C- and L-band). Other wavelengths and bands may be used.

Example Clause 3: The method of Example Clause 1 or Example Clause 2, further may include receiving, via the optical fiber and the optical circulator coupled to the optical transceiver, the optical signal, where the optical signal may include a first wavelength in a wavelength band, and where the transmitting, via the optical fiber and the optical circulator coupled to the optical transceiver, the optical signal may include transmitting, via the optical fiber and the optical circulator coupled to the optical transceiver, the optical signal may include a second wavelength in the wavelength band.

Example Clause 4: The method of any one of Example Clauses 1-3, where the determining fiber data indicative of at least a condition of the optical fiber may include determining a defect in the optical fiber based on the receiving the optical signal via the optical fiber and the optical circulator coupled to the optical transceiver.

Example Clause 5: The method of any one of Example Clauses 1-4, further may include determining a location of the defect in the optical fiber based on a difference in time between the receiving the optical signal and the transmitting the optical signal.

Example Clause 6: The method of any one of Example Clauses 1-5, further may include causing an operator to be dispatched to the location, where the operator is in possession of a handheld device, where the handheld device may include a second optical circulator coupled to a second optical transceiver, and where the handheld device is coupled to the optical fiber at the location.

Example Clause 7: The method of any one of Example Clauses 1-6, further may include: transmitting, via the optical fiber and the optical circulator coupled to the optical transceiver, a second optical signal; and receiving, via the optical fiber and the optical circulator coupled to the optical transceiver, a response signal, where the response signal is generated by the handheld device in response to the second optical signal.

Example Clause 8: The method of any one of Example Clauses 1-7, further may include: receiving, via the optical fiber and the optical circulator coupled to the optical transceiver, a second optical signal, where the second optical signal is generated by the handheld device; and transmitting, via the optical fiber and the optical circulator coupled to the optical transceiver, a response signal, where the response signal is generated in response to the second optical signal.

Example Clause 9: The method of any one of Example Clauses 1-8, where documentation associated with the optical fiber is automatically updated to indicate that the optical fiber has the defect, and where the documentation associated with the optical fiber is automatically updated to indicate the location of the defect.

Example Clause 10: The method of any one of Example Clauses 1-9, where a mapping associated with the optical fiber is automatically updated to indicate that the optical fiber has the defect, and where the mapping associated with the optical fiber is automatically updated to indicate the location of the defect.

Example Clause 11: The method of any one of Example Clauses 1-10, where the defect may include at least one of: an aperture, a bend, and a complete separation.

Example Clause 12: The method of any one of Example Clauses 1-11, further may include receiving, via the optical fiber and the optical circulator coupled to the optical transceiver, a second optical signal, where the second optical signal may include signal data.

Example Clause 13: The method of any one of Example Clauses 1-12, where the signal data may include data indicative of a source of the second optical signal.

Example Clause 14: The method of any one of Example Clauses 1-13, where the source may include one or more of a hub, switch, and port based on the signal data.

Example Clause 15: The method of any one of Example Clauses 1-14, where a distance to the source via the optical fiber is determined based on a difference between a time associated with the receiving the second optical signal and the transmitting the (first) optical signal.

Example Clause 16: The method of any one of Example Clauses 1-15, where a latency associated with the source via the optical fiber is determined based on a difference between a time associated with the receiving the second optical signal and the transmitting the (first) optical signal.

Example Clause 17: The method of any one of Example Clauses 1-16, where documentation associated with the optical fiber is automatically updated to indicate that the optical fiber is connected to the source, and where the documentation associated with the optical fiber is automatically updated to indicate the latency associated with the source via the optical fiber.

Example Clause 18: The method of any one of Example Clauses 1-17, where a mapping associated with the optical fiber is automatically updated to indicate that the optical fiber is connected to the source, and where the mapping associated with the optical fiber is automatically updated to indicate the latency associated with the source via the optical fiber.

Example Clause 19: The method of any one of Example Clauses 1-18, where a mapping associated with the optical fiber is automatically updated to indicate that the optical fiber is connected to an unknown port.

Example Clause 20: The method of any one of Example Clauses 1-19, where the transmission data indicates loss of the optical signal via the optical fiber.

Example Clause 21: The method of any one of Example Clauses 1-20, where documentation associated with the optical fiber is automatically updated to indicate that the optical fiber is connected to an unknown port.

Example Clause 22: A method may include: causing, at a first hub, an optical signal to be transmitted via an optical fiber and a first optical circulator coupled to a first optical transceiver for reception by a second optical circulator coupled to a second optical transceiver; receiving transmission data indicative of reception or loss of the optical signal via the optical fiber; and determining, based on at least the transmission data, fiber data indictive of at least a condition of the optical fiber.

Example Clause 23: The method of Example Clause 22, where the second optical circulator and the second optical transceiver are located at the first hub.

Example Clause 24: The method of Example Clause 22 or Example Clause 23, where the transmission data may include local data.

Example Clause 25: The method of any one of Example Clauses 22-24, where the second optical circulator and the second optical transceiver are located at a second hub, where the second hub is different from the first hub.

Example Clause 26: The method of any one of Example Clauses 22-25, where the transmission data may include an indication of reception of the optical signal by the second optical circulator coupled to the second optical transceiver.

Example Clause 27: The method of any one of Example Clauses 22-26, where documentation associated with the optical fiber is automatically updated to indicate that the optical fiber connects one or more of: the first hub and the second hub; and the first optical transceiver and the second optical transceiver.

Example Clause 28: The method of any one of Example Clauses 22-27, where a mapping associated with the optical fiber is automatically updated to indicate that the optical fiber connects one or more of: the first hub and the second hub; and the first optical transceiver and the second optical transceiver.

Example Clause 29: The method of any one of Example Clauses 22-28, where a time to travel is determined by a difference between a time associated the reception of the optical signal and a time associated with the causing the optical signal to be transmitted.

Example Clause 30: The method of any one of Example Clauses 22-29, where documentation associated with the optical fiber is automatically updated to indicate a distance, via the optical fiber, between one or more of: the first hub and the second hub; and the first optical transceiver and the second optical transceiver.

Example Clause 31: The method of any one of Example Clauses 22-30, where a mapping associated with the optical fiber is automatically updated to indicate a distance, via the optical fiber, between one or more of: the first hub and the second hub; and the first optical transceiver and the second optical transceiver.

Example Clause 32: The method of any one of Example Clauses 22-31, where a latency is determined by a difference between a time associated the reception of the optical signal and a time associated with the causing the optical signal to be transmitted.

Example Clause 33: The method of any one of Example Clauses 22-32, where documentation associated with the optical fiber is automatically updated to indicate the latency, via the optical fiber, between one or more of: the first hub and the second hub; and the first optical transceiver and the second optical transceiver.

Example Clause 34: The method of any one of Example Clauses 22-33, where a mapping associated with the optical fiber is automatically updated to indicate the latency, via the optical fiber, between one or more of: the first hub and the second hub; and the first optical transceiver and the second optical transceiver.

Example Clause 35: The method of any one of Example Clauses 22-34, where the transmission data may include an indication of reception of the optical signal by the first optical circulator coupled to the first optical transceiver.

Example Clause 36: The method of any one of Example Clauses 22-35, where the determining fiber data indicative of at least a condition of the optical fiber may include determining a defect in the optical fiber based on the reception of the optical signal by the first optical circulator coupled to the first optical transceiver.

Example Clause 37: The method of any one of Example Clauses 22-36, further may include determining a location of the defect in the optical fiber based on a difference between a time associated the reception of the optical signal and a time associated with the causing the optical signal to be transmitted.

Example Clause 38: The method of any one of Example Clauses 22-37, where documentation associated with the optical fiber is automatically updated to indicate that the optical fiber has the defect, and where the documentation associated with the optical fiber is automatically updated to indicate the location of the defect.

Example Clause 39: The method of any one of Example Clauses 22-38, where a mapping associated with the optical fiber is automatically updated to indicate that the optical fiber has the defect, and where the mapping associated with the optical fiber is automatically updated to indicate the location of the defect.

Example Clause 40: The method of any one of Example Clauses 22-39, where the defect may include at least one of: an aperture, a bend, and a complete separation.

Example Clause 41: The method of any one of Example Clauses 22-40, where the optical signal may include a wavelength in a wavelength band, and where the wavelength band may include a 1591 nanometer wavelength. The wavelength band comprises 1260 nm to 1625 nm, or 1565 nm to 1625 nm, or other optical bands such as optical communications bands (e.g., O-, E-, S-, C- and L-band). Other wavelengths and bands may be used.

Example Clause 42: A method may include: receiving transmission data indicative of reception or loss of an optical signal via an optical fiber, where the optical signal was transmitted via the optical fiber and a first optical circulator coupled to a first optical transceiver, at a first hub, for reception by a second optical circulator coupled to a second optical transceiver; determining, based on at least the transmission data, fiber data indictive of at least a condition of the optical fiber; and updating a mapping associated with the optical fiber based on at least the fiber data.

Example Clause 43: The method of Example Clause 42, where the second optical circulator and the second optical transceiver are located at the first hub.

Example Clause 44: The method of Example Clause 42 or Example Clause 43, where the transmission data may include local data.

Example Clause 45: The method of any one of Example Clauses 42-44, where the second optical circulator and the second optical transceiver are located at a second hub, where the second hub is different from the first hub.

Example Clause 46: The method of any one of Example Clauses 42-45, where the transmission data may include an indication of reception of the optical signal by the second optical circulator coupled to the second optical transceiver.

Example Clause 47: The method of any one of Example Clauses 42-46, where documentation associated with the optical fiber is automatically updated to indicate that the optical fiber connects one or more of: the first hub and the second hub; and the first optical transceiver and the second optical transceiver.

Example Clause 48: The method of any one of Example Clauses 42-47, where the updating a mapping associated with the optical fiber based on at least the fiber data may include automatically updating the mapping associated with the optical fiber to indicate that the optical fiber connects one or more of: the first hub and the second hub; and the first optical transceiver and the second optical transceiver.

Example Clause 49: The method of any one of Example Clauses 42-48, where the transmission data may include an indication of the optical signal being transmitted via the first optical circulator coupled to the first optical transceiver at a first time, where the transmission data may include an indication of the reception of the optical signal at a second time, and where a time to travel is determined by a difference between the second time and the first time.

Example Clause 50: The method of any one of Example Clauses 42-49, where documentation associated with the optical fiber is automatically updated to indicate a distance, via the optical fiber and based on the time to travel, between one or more of: the first hub and the second hub; and the first optical transceiver and the second optical transceiver.

Example Clause 51: The method of any one of Example Clauses 42-50, where the updating a mapping associated with the optical fiber based on at least the fiber data may include automatically updating the mapping associated with the optical fiber to indicate a distance, via the optical fiber and based on the time to travel, between one or more of: the first hub and the second hub; and the first optical transceiver and the second optical transceiver.

Example Clause 52: The method of any one of Example Clauses 42-51, where the transmission data may include an indication of the optical signal being transmitted via the first optical circulator coupled to the first optical transceiver at a first time, where the transmission data may include an indication of the reception of the optical signal at a second time, and where a latency is determined by a difference between the second time and the first time.

Example Clause 53: The method of any one of Example Clauses 42-52, where documentation associated with the optical fiber is automatically updated to indicate the latency, via the optical fiber, between one or more of: the first hub and the second hub; and the first optical transceiver and the second optical transceiver.

Example Clause 54: The method of any one of Example Clauses 42-53, where the updating a mapping associated with the optical fiber based on at least the fiber data may include automatically updating a mapping associated with the optical fiber to indicate the latency, via the optical fiber, between one or more of: the first hub and the second hub; and the first optical transceiver and the second optical transceiver.

Example Clause 55: The method of any one of Example Clauses 42-54, where the transmission data may include an indication of reception of the optical signal by the first optical circulator coupled to the first optical transceiver.

Example Clause 56: The method of any one of Example Clauses 42-55, where the determining fiber data indicative of at least a condition of the optical fiber may include determining a defect in the optical fiber based on the reception of the optical signal by the first optical circulator coupled to the first optical transceiver.

Example Clause 57: The method of any one of Example Clauses 42-56, where the transmission data may include an indication of the optical signal being transmitted via the first optical circulator coupled to the first optical transceiver at a first time, where the transmission data may include an indication of the reception of the optical signal at a second time, and further may include determining a location of the defect in the optical fiber based on a difference between the second time and the first time.

Example Clause 58: The method of any one of Example Clauses 42-57, where documentation associated with the optical fiber is automatically updated to indicate that the optical fiber has the defect, and where the documentation associated with the optical fiber is automatically updated to indicate the location of the defect.

Example Clause 59: The method of any one of Example Clauses 42-58, where the updating a mapping associated with the optical fiber based on at least the fiber data may include automatically updating a mapping associated with the optical fiber to indicate that the optical fiber has the defect, and where the mapping associated with the optical fiber is automatically updated to indicate the location of the defect.

Example Clause 60: The method of any one of Example Clauses 42-59, where the defect may include at least one of: an aperture, a bend, and a complete separation.

Example Clause 61: The method of any one of Example Clauses 42-60, where the optical signal may include a wavelength in a wavelength band, and where the wavelength band may include a 1591 nanometer wavelength. The wavelength band comprises 1260 nm to 1625 nm, or 1565 nm to 1625 nm, or other optical bands such as optical communications bands (e.g., O-, E-, S-, C- and L-band). Other wavelengths and bands may be used.

Example Clause 62: A system may include: one or more processors configured to: transmit, via an optical fiber and an optical circulator coupled to an optical transceiver, an optical signal; receive transmission data indicative of reception or loss of the optical signal via the optical fiber; and determine, based on at least the transmission data, fiber data indictive of at least a condition of the optical fiber.

Example Clause 63: The system of Example Clause 62, where the optical signal may include a wavelength in a wavelength band, and where the wavelength band may include a 1591 nanometer wavelength. The wavelength band comprises 1260 nm to 1625 nm, or 1565 nm to 1625 nm, or other optical bands such as optical communications bands (e.g., O-, E-, S-, C- and L-band). Other wavelengths and bands may be used.

Example Clause 64: The system of Example Clause 62 or Example Clause 63, where the one or more processors are further configured to receive, via the optical fiber and the optical circulator coupled to the optical transceiver, the optical signal, where the optical signal may include a first wavelength in a wavelength band, and where the transmitting, via the optical fiber and the optical circulator coupled to the optical transceiver, the optical signal may include transmitting, via the optical fiber and the optical circulator coupled to the optical transceiver, the optical signal may include a second wavelength in the wavelength band.

Example Clause 65: The system of any one of Example Clauses 62-64, where the determining fiber data indicative of at least a condition of the optical fiber may include determining a defect in the optical fiber based on the receiving the optical signal via the optical fiber and the optical circulator coupled to the optical transceiver.

Example Clause 66: The system of any one of Example Clauses 62-65, where the one or more processors are further configured to determine a location of the defect in the optical fiber based on a difference in time between the receiving the optical signal and the transmitting the optical signal.

Example Clause 67: The system of any one of Example Clauses 62-66, where the one or more processors are further configured to cause an operator to be dispatched to the location, where the operator is in possession of a handheld device, where the handheld device may include a second optical circulator coupled to a second optical transceiver, and where the handheld device is coupled to the optical fiber at the location.

Example Clause 68: The system of any one of Example Clauses 62-67, where the one or more processors are further configured to: transmit, via the optical fiber and the optical circulator coupled to the optical transceiver, a second optical signal; and receive, via the optical fiber and the optical circulator coupled to the optical transceiver, a response signal, where the response signal is generated by the handheld device in response to the second optical signal.

Example Clause 69: The system of any one of Example Clauses 62-68, where the one or more processors are further configured to: receive, via the optical fiber and the optical circulator coupled to the optical transceiver, a second optical signal, where the second optical signal is generated by the handheld device; and transmit, via the optical fiber and the optical circulator coupled to the optical transceiver, a response signal, where the response signal is generated in response to the second optical signal.

Example Clause 70: The system of any one of Example Clauses 62-69, where documentation associated with the optical fiber is automatically updated to indicate that the optical fiber has the defect, and where the documentation associated with the optical fiber is automatically updated to indicate the location of the defect.

Example Clause 71: The system of any one of Example Clauses 62-70, where a mapping associated with the optical fiber is automatically updated to indicate that the optical fiber has the defect, and where the mapping associated with the optical fiber is automatically updated to indicate the location of the defect.

Example Clause 72: The system of any one of Example Clauses 62-71, where the defect may include at least one of: an aperture, a bend, and a complete separation.

Example Clause 73: The system of any one of Example Clauses 62-72, where the one or more processors are further configured to receive, via the optical fiber and the optical circulator coupled to the optical transceiver, a second optical signal, where the second optical signal may include signal data.

Example Clause 74: The system of any one of Example Clauses 62-73, where the signal data may include data indicative of a source of the second optical signal.

Example Clause 75: The system of any one of Example Clauses 62-74, where the source may include one or more of a hub, switch, and port based on the signal data.

Example Clause 76: The system of any one of Example Clauses 62-75, where a distance to the source via the optical fiber is determined based on a difference between a time associated with the receiving the second optical signal and the transmitting the (first) optical signal.

Example Clause 77: The system of any one of Example Clauses 62-76, where a latency associated with the source via the optical fiber is determined based on a difference between a time associated with the receiving the second optical signal and the transmitting the (first) optical signal.

Example Clause 78: The system of any one of Example Clauses 62-77, where documentation associated with the optical fiber is automatically updated to indicate that the optical fiber is connected to the source, and where the documentation associated with the optical fiber is automatically updated to indicate the latency associated with the source via the optical fiber.

Example Clause 79: The system of any one of Example Clauses 62-78, where a mapping associated with the optical fiber is automatically updated to indicate that the optical fiber is connected to the source, and where the mapping associated with the optical fiber is automatically updated to indicate the latency associated with the source via the optical fiber.

Example Clause 80: The system of any one of Example Clauses 62-79, where a mapping associated with the optical fiber is automatically updated to indicate that the optical fiber is connected to an unknown port.

Example Clause 81: The system of any one of Example Clauses 62-80, where the transmission data indicates loss of the optical signal via the optical fiber.

Example Clause 82: The system of any one of Example Clauses 62-81, where documentation associated with the optical fiber is automatically updated to indicate that the optical fiber is connected to an unknown port.

Example Clause 83: A system may include: one or more processors configured to: cause, at a first hub, an optical signal to be transmitted via an optical fiber and a first optical circulator coupled to a first optical transceiver for reception by a second optical circulator coupled to a second optical transceiver; receive transmission data indicative of reception or loss of the optical signal via the optical fiber; and determine, based on at least the transmission data, fiber data indictive of at least a condition of the optical fiber.

Example Clause 84: The system of Example Clause 83, where the second optical circulator and the second optical transceiver are located at the first hub.

Example Clause 85: The system of Example Clause 83 or Example Clause 84, where the transmission data may include local data.

Example Clause 86: The system of any one of Example Clauses 83-85, where the second optical circulator and the second optical transceiver are located at a second hub, where the second hub is different from the first hub.

Example Clause 87: The system of any one of Example Clauses 83-86, where the transmission data may include an indication of reception of the optical signal by the second optical circulator coupled to the second optical transceiver.

Example Clause 88: The system of any one of Example Clauses 83-87, where documentation associated with the optical fiber is automatically updated to indicate that the optical fiber connects one or more of: the first hub and the second hub; and the first optical transceiver and the second optical transceiver.

Example Clause 89: The system of any one of Example Clauses 83-88, where a mapping associated with the optical fiber is automatically updated to indicate that the optical fiber connects one or more of: the first hub and the second hub; and the first optical transceiver and the second optical transceiver.

Example Clause 90: The system of any one of Example Clauses 83-89, where a time to travel is determined by a difference between a time associated the reception of the optical signal and a time associated with the causing the optical signal to be transmitted.

Example Clause 91: The system of any one of Example Clauses 83-90, where documentation associated with the optical fiber is automatically updated to indicate a distance, via the optical fiber, between one or more of: the first hub and the second hub; and the first optical transceiver and the second optical transceiver.

Example Clause 92: The system of any one of Example Clauses 83-91, where a mapping associated with the optical fiber is automatically updated to indicate a distance, via the optical fiber, between one or more of: the first hub and the second hub; and the first optical transceiver and the second optical transceiver.

Example Clause 93: The system of any one of Example Clauses 83-92, where a latency is determined by a difference between a time associated the reception of the optical signal and a time associated with the causing the optical signal to be transmitted.

Example Clause 94: The system of any one of Example Clauses 83-93, where documentation associated with the optical fiber is automatically updated to indicate the latency, via the optical fiber, between one or more of: the first hub and the second hub; and the first optical transceiver and the second optical transceiver.

Example Clause 95: The system of any one of Example Clauses 83-94, where a mapping associated with the optical fiber is automatically updated to indicate the latency, via the optical fiber, between one or more of: the first hub and the second hub; and the first optical transceiver and the second optical transceiver.

Example Clause 96: The system of any one of Example Clauses 83-95, where the transmission data may include an indication of reception of the optical signal by the first optical circulator coupled to the first optical transceiver.

Example Clause 97: The system of any one of Example Clauses 83-96, where the determining fiber data indicative of at least a condition of the optical fiber may include determining a defect in the optical fiber based on the reception of the optical signal by the first optical circulator coupled to the first optical transceiver.

Example Clause 98: The system of any one of Example Clauses 83-97, where the one or more processors are further configured to determine a location of the defect in the optical fiber based on a difference between a time associated the reception of the optical signal and a time associated with the causing the optical signal to be transmitted.

Example Clause 99: The system of any one of Example Clauses 83-98, where documentation associated with the optical fiber is automatically updated to indicate that the optical fiber has the defect, and where the documentation associated with the optical fiber is automatically updated to indicate the location of the defect.

Example Clause 100: The system of any one of Example Clauses 83-99, where a mapping associated with the optical fiber is automatically updated to indicate that the optical fiber has the defect, and where the mapping associated with the optical fiber is automatically updated to indicate the location of the defect.

Example Clause 101: The system of any one of Example Clauses 83-100, where the defect may include at least one of: an aperture, a bend, and a complete separation.

Example Clause 102: The system of any one of Example Clauses 83-101, where the optical signal may include a wavelength in a wavelength band, and where the wavelength band may include a 1591 nanometer wavelength. The wavelength band comprises 1260 nm to 1625 nm, or 1565 nm to 1625 nm, or other optical bands such as optical communications bands (e.g., O-, E-, S-, C- and L-band). Other wavelengths and bands may be used.

Example Clause 103: A system may include: one or more processors configured to: receive transmission data indicative of reception or loss of an optical signal via an optical fiber, where the optical signal was transmitted via the optical fiber and a first optical circulator coupled to a first optical transceiver, at a first hub, for reception by a second optical circulator coupled to a second optical transceiver; determine, based on at least the transmission data, fiber data indictive of at least a condition of the optical fiber; and update a mapping associated with the optical fiber based on at least the fiber data.

Example Clause 104: The system of Example Clause 103, where the second optical circulator and the second optical transceiver are located at the first hub.

Example Clause 105: The system of Example Clause 103 or Example Clause 104, where the transmission data may include local data.

Example Clause 106: The system of any one of Example Clauses 103-105, where the second optical circulator and the second optical transceiver are located at a second hub, where the second hub is different from the first hub.

Example Clause 107: The system of any one of Example Clauses 103-106, where the transmission data may include an indication of reception of the optical signal by the second optical circulator coupled to the second optical transceiver.

Example Clause 108: The system of any one of Example Clauses 103-107, where documentation associated with the optical fiber is automatically updated to indicate that the optical fiber connects one or more of: the first hub and the second hub; and the first optical transceiver and the second optical transceiver.

Example Clause 109: The system of any one of Example Clauses 103-108, where the updating a mapping associated with the optical fiber based on at least the fiber data may include automatically updating the mapping associated with the optical fiber to indicate that the optical fiber connects one or more of: the first hub and the second hub; and the first optical transceiver and the second optical transceiver.

Example Clause 110: The system of any one of Example Clauses 103-109, where the transmission data may include an indication of the optical signal being transmitted via the first optical circulator coupled to the first optical transceiver at a first time, where the transmission data may include an indication of the reception of the optical signal at a second time, and where a time to travel is determined by a difference between the second time and the first time.

Example Clause 111: The system of any one of Example Clauses 103-110, where documentation associated with the optical fiber is automatically updated to indicate a distance, via the optical fiber and based on the time to travel, between one or more of: the first hub and the second hub; and the first optical transceiver and the second optical transceiver.

Example Clause 112: The system of any one of Example Clauses 103-111, where the updating a mapping associated with the optical fiber based on at least the fiber data may include automatically updating the mapping associated with the optical fiber to indicate a distance, via the optical fiber and based on the time to travel, between one or more of: the first hub and the second hub; and the first optical transceiver and the second optical transceiver.

Example Clause 113: The system of any one of Example Clauses 103-112, where the transmission data may include an indication of the optical signal being transmitted via the first optical circulator coupled to the first optical transceiver at a first time, where the transmission data may include an indication of the reception of the optical signal at a second time, and where a latency is determined by a difference between the second time and the first time.

Example Clause 114: The system of any one of Example Clauses 103-113, where documentation associated with the optical fiber is automatically updated to indicate the latency, via the optical fiber, between one or more of: the first hub and the second hub; and the first optical transceiver and the second optical transceiver.

Example Clause 115: The system of any one of Example Clauses 103-114, where the updating a mapping associated with the optical fiber based on at least the fiber data may include automatically updating a mapping associated with the optical fiber to indicate the latency, via the optical fiber, between one or more of: the first hub and the second hub; and the first optical transceiver and the second optical transceiver.

Example Clause 116: The system of any one of Example Clauses 103-115, where the transmission data may include an indication of reception of the optical signal by the first optical circulator coupled to the first optical transceiver.

Example Clause 117: The system of any one of Example Clauses 103-116, where the determining fiber data indicative of at least a condition of the optical fiber may include determining a defect in the optical fiber based on the reception of the optical signal by the first optical circulator coupled to the first optical transceiver.

Example Clause 118: The system of any one of Example Clauses 103-117, where the transmission data may include an indication of the optical signal being transmitted via the first optical circulator coupled to the first optical transceiver at a first time, where the transmission data may include an indication of the reception of the optical signal at a second time, and where the one or more processors are further configured to determine a location of the defect in the optical fiber based on a difference between the second time and the first time.

Example Clause 119: The system of any one of Example Clauses 103-118, where documentation associated with the optical fiber is automatically updated to indicate that the optical fiber has the defect, and where the documentation associated with the optical fiber is automatically updated to indicate the location of the defect.

Example Clause 120: The system of any one of Example Clauses 103-119, where the updating a mapping associated with the optical fiber based on at least the fiber data may include automatically updating a mapping associated with the optical fiber to indicate that the optical fiber has the defect, and where the mapping associated with the optical fiber is automatically updated to indicate the location of the defect.

Example Clause 121: The system of any one of Example Clauses 103-120, where the defect may include at least one of: an aperture, a bend, and a complete separation.

Example Clause 122: The system of any one of Example Clauses 103-121, where the optical signal may include a wavelength in a wavelength band, and where the wavelength band may include a 1591 nanometer wavelength. The wavelength band comprises 1260 nm to 1625 nm, or 1565 nm to 1625 nm, or other optical bands such as optical communications bands (e.g., O-, E-, S-, C- and L-band). Other wavelengths and bands may be used.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method comprising:
transmitting, via a transmit port of an optical transceiver, via an optical circulator optically coupled to the optical transceiver, and via an optical fiber optically coupled to the optical circulator, an optical signal, wherein the optical circulator is non-reciprocal and is configured to unidirectionally pass the optical signal from the transmit port to the optical fiber;
receiving transmission data indicative of reception or loss of the optical signal via the optical fiber; and
determining, based on at least the transmission data, fiber data indictive of at least a condition of the optical fiber.

2. The method of claim 1, wherein the optical signal comprises a wavelength in a wavelength band, and wherein the wavelength band comprises a 1591 nanometer wavelength.

3. The method of claim 2, wherein the wavelength band comprises 1260 nm to 1625 nm, or 1565 nm to 1625 nm.

4. The method of claim 1, wherein the transmission data is received via the optical circulator and via a receive port of the optical transceiver, wherein the optical circulator is configured to unidirectionally pass the optical signal from the optical circulator to the receive port.

5. The method of claim 1, wherein the determining fiber data indicative of at least a condition of the optical fiber comprises determining a defect in the optical fiber.

6. The method of claim 5, further comprising determining a location of the defect in the optical fiber based on a difference in time between the receiving the optical signal and the transmitting the optical signal.

7. The method of claim 6, wherein documentation associated with the optical fiber is automatically updated to indicate that the optical fiber has the defect, and wherein the documentation associated with the optical fiber is automatically updated to indicate the location of the defect.

8. A method comprising:
causing, at a first hub, an optical signal to be transmitted via a transmit port of a first optical transceiver, via an optical circulator optically coupled to the first optical transceiver, and via an optical fiber optically coupled to the optical circulator, wherein the optical circulator is non-reciprocal and is configured to unidirectionally pass the optical signal from the transmit port to the optical fiber;
receiving transmission data indicative of reception or loss of the optical signal via the optical fiber; and
determining, based on at least the transmission data, fiber data indictive of at least a condition of the optical fiber.

9. The method of claim 8, wherein the transmission data is received via a second optical circulator coupled to a second optical transceiver.

10. The method of claim 9, wherein the second optical circulator and the second optical transceiver are disposed at the first hub.

11. The method of claim 9, wherein the second optical circulator and the second optical transceiver are disposed at a second hub different from the first hub.

12. The method of claim 9, wherein the transmission data comprises an indication of reception of the optical signal by the second optical transceiver.

13. The method of claim 9, wherein documentation associated with the optical fiber is automatically updated to indicate that the optical fiber connects the first optical transceiver and the second optical transceiver.

14. The method of claim 13, wherein the documentation comprises a geographical mapping of the optical fiber.

15. The method of claim 9, wherein the optical signal comprises a wavelength in a wavelength band, and wherein the wavelength band comprises a 1591 nanometer wavelength.

16. The method of claim 15, wherein the wavelength band comprises 1260 nm to 1625 nm, or 1565 nm to 1625 nm.

17. A method comprising:
receiving transmission data indicative of reception or loss of an optical signal via an optical fiber, wherein the optical signal is received via an optical circulator coupled to a receive port of an optical transceiver, wherein the optical circulator is non-reciprocal and is configured to unidirectionally pass the optical signal from the optical fiber to the receive port;
determining, based on at least the transmission data, fiber data indictive of at least a condition of the optical fiber; and
updating documentation associated with the optical fiber based on at least the fiber data.

18. The method of claim 17, wherein the documentation comprises a geographical mapping of the optical fiber.

19. The method of claim 17, wherein the optical signal comprises a wavelength in a wavelength band, and wherein the wavelength band comprises a 1591 nanometer wavelength.

20. The method of claim 19, wherein the wavelength band comprises 1260 nm to 1625 nm, or 1565 nm to 1625 nm.
